(19) United States
(12) Patent Application Publication
(10) Pub. No.: US 2023/0322985 A1
(43) Pub. Date: Oct. 12, 2023

(54) CURABLE RESIN COMPOSITION AND CEMENTED LENS

(71) Applicant: FUJIFILM Corporation, Tokyo (JP)

(72) Inventor: Takafumi NAKAYAMA, Kanagawa (JP)

(73) Assignee: FUJIFILM Corporation, Tokyo (JP)

(21) Appl. No.: 18/330,791

(22) Filed: Jun. 7, 2023

Related U.S. Application Data
(63) Continuation of application No. PCT/JP2022/007744, filed on Feb. 24, 2022.

(30) Foreign Application Priority Data
Feb. 25, 2021 (JP) 2021-029032

(51) Int. Cl. C08F 220/18; C08F 220/56; C08F 220/20; C08F 222/24; C08F 2/48; C08K 5/20; C09J 133/10; C09J 133/14; G02B 3/00; G02B 1/04; G02B 13/00

(52) U.S. Cl. CPC C08F 220/1806; C08F 220/1804; C08F 220/56; C08F 220/20; C08F 222/24; C08F 2/48; C08K 5/20; C09J 133/10; C09J 133/14; G02B 3/00; G02B 1/041; G02B 13/006; C09J 2433/00

(57) ABSTRACT

Provided are a curable resin composition containing a compound represented by General Formula (1) and a component (B); and a cemented lens using the composition. Component (B): a polymer including a structural unit (bi) having an aromatic ring and a structural unit (b2) having a hydrogen bonding group, in which a proportion of the structural unit (b1) in all structural units constituting the polymer is 10% by mass or more and a proportion of the structural unit (b2) in all structural units constituting the polymer is 3% by mass or more, where the structural unit (bi) has no hydrogen bonding group.

Pol¹-Sp^{a}-L¹-Ar-L²-Sp^{b}-Pol² General Formula (1)

Ar represents an aromatic ring group represented by a specific formula, L¹, L², Sp^{a}, and Sp^{b} represent a single bond or a specific group, and Pol¹ and Pol² represent a polymerizable group.

### CROSS-REFERENCE TO RELATED APPLICATIONS

This application is a Continuation of PCT International Application No. PCT/JP2022/007744 filed on Feb. 24, 2022, which claims priority under 35 U.S.C. § 119 (a) to Japanese Patent Application No. 2021-029032 filed in Japan on Feb. 25, 2021. Each of the above applications is hereby expressly incorporated by reference, in its entirety, into the present application.

### BACKGROUND OF THE INVENTION

### 1. Field of the Invention

The present invention relates to a curable resin composition and a cemented lens.

### 2. Description of the Related Art

For optical lenses for imaging modules such as a camera, a video camera or a mobile phone with a camera, a videophone, and a door phone with a camera, a resin cured product which can be mass-produced and is excellent in workability has been used as an optical member to replace a glass material in the related art.

It has been studied to correct chromatic aberration occurring in an optical lens used in the imaging module, which is required to be miniaturized, by reducing Abbe number of the resin cured product forming the optical member.

In the above-described resin cured product, compounds (monomers) including a skeleton such as benzodithiol, benzothiazole, and phenylhydrazone have been used as an absorbent in a near-ultraviolet region. These compounds are also excellent in fastness to ultraviolet ray irradiation, and it has been proposed that a curable resin composition containing the compound is used as “ultraviolet cut layer” that protects a resin material and the like which is easily deteriorated by ultraviolet rays, and is also applied as an adhesive for lenses, which bonds a glass lens and a resin lens (for example, WO2019/131572A).

WO2020/171197A discloses a curable resin composition containing indium tin oxide (ITO) nanoparticles and a monomer having a benzodithiol skeleton.

### SUMMARY OF THE INVENTION

According to the study by the present inventor, it has been found that, in a case where a curable resin composition in the related art, which contains a compound including a skeleton such as benzodithiol, benzothiazole, and phenylhydrazone, is blended, it cannot be said that adhesiveness of a cured product to be obtained to a glass substrate is sufficient, and further improvement is required for use as an adhesive for lenses. In addition, it has been found that, in the blending of the curable resin composition disclosed in WO2019/131572A, it cannot be said that compatibility between the compound including a skeleton such as benzodithiol, benzothiazole, and phenylhydrazone and other resin components in the composition is sufficient, and further improvement is required in terms of obtaining a cured product having high transmittance. In addition, the technique disclosed in WO2020/171197A provides a resin composition which can be used as a low Abbe number resin for a multilayer diffractive lattice element, and does not disclose application to an adhesive.

An object of the present invention is to provide a curable resin composition containing a monomer including a skeleton such as benzodithiol, benzothiazole, and phenylhydrazone, and with the curable resin composition, a cured product having excellent adhesiveness to a glass substrate and excellent transmittance can be obtained. Another object of the present invention is to provide a cemented lens including a cured product obtained from the curable resin composition.

As a result of intensive studies for achieving the above-described objects, it has been found that, in a curable resin composition containing a compound (monomer) having a skeleton such as benzodithiol, benzothiazole, and phenylhydrazone, by containing a polymer having a specific structure including a structural unit having an aromatic ring and a structural unit having a hydrogen bonding group at a specific content ratio, adhesiveness to glass can be effectively increased without impairing the transmittance of the cured product to be obtained in a visible region.

That is, the above-described objects of the present invention have been achieved by the following methods.

<1>

A curable resin composition comprising:
a component (A); and
a component (B),
the component (A): a compound represented by General Formula (1), component (B): a polymer including a structural unit (b1) having an aromatic ring and a structural unit (b2) having a hydrogen bonding group, in which a proportion of the structural unit (b1) in all structural units constituting the polymer is 10% by mass or more and a proportion of the structural unit (b2) in all structural units constituting the polymer is 3% by mass or more, where the structural unit (b1) has no hydrogen bonding group,

Pol¹-Sp^{a}-L¹-Ar-L²-Sp^{b}-Pol² General Formula (1)
in the formula, Ar represents an aromatic ring group represented by any of General Formula (2-1), . . . , or (2-4),
L¹ and L² represent a single bond, —O—, —S—, —C(═O)—, —OC(═O)—, —C(═O)O—, —OC(═O)O—, —NR¹⁰¹C(═O)—, —C(═O)NR¹⁰²—, —OC(═O)NR¹⁰³—, —NR¹⁰⁴C(═O)O—, —SC(═O)—, or —C(═O)S—,
R¹⁰¹ to R¹⁰⁴ represent -Sp^{c}-Pol³ or a halogen atom,
Sp^{a} and Sp^{b} represent a single bond, a linear alkylene group having 1 to 30 carbon atoms, which may have a substituent, or a group in which, in a linear alkylene group having 2 to 30 carbon atoms, which may have a substituent, one or two or more —CH₂—'s excluding a linking portion to L¹ or L² are substituted by a group selected from —O—, —S—, >C(═O), or >NR¹¹¹,
R¹¹¹ represents -Sp^{d}-Pol⁴ or a halogen atom,
Sp^{c} and Sp^{d} represent a single bond or a divalent linking group, and
Pol¹ and Pol² represent a polymerizable group, and Pol³ and Pol⁴ represent a hydrogen atom or a polymerizable group,

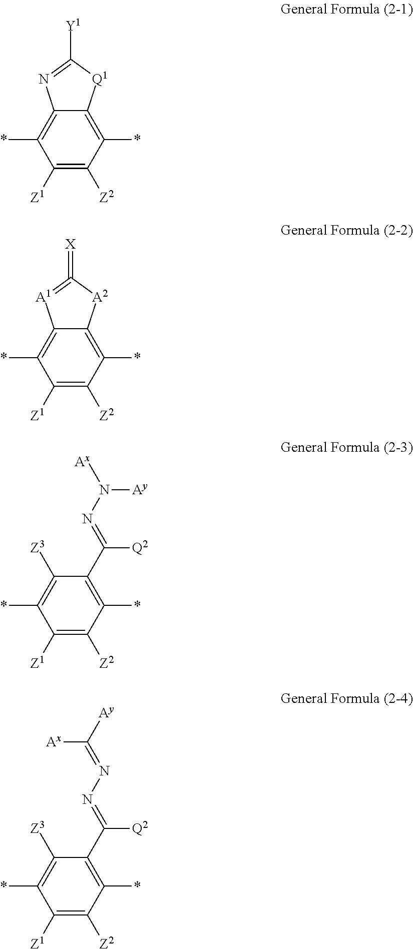

in the formulae, Q¹ represents —S—, —O—, or >NR¹¹, and R¹¹ represents a hydrogen atom or an alkyl group having 1 to 6 carbon atoms,
Y¹ represents an alkyl group having 1 to 6 carbon atoms, an aromatic hydrocarbon group having 6 to 12 carbon atoms, or an aromatic heterocyclic group having 3 to 12 carbon atoms,
Z¹, Z², and Z³ represent a hydrogen atom, an aliphatic hydrocarbon group having 1 to 20 carbon atoms, an alkoxy group having 1 to 20 carbon atoms, an alicyclic hydrocarbon group having 3 to 20 carbon atoms, an aromatic hydrocarbon group having 6 to 20 carbon atoms, a halogen atom, a cyano group, a nitro group, —NR¹²R¹³, or —SR¹², Z¹ and Z² may be bonded to each other to form an aromatic hydrocarbon ring or an aromatic heterocyclic ring, R¹² and R¹³ represent a hydrogen atom or an alkyl group having 1 to 6 carbon atoms,
   A¹ and A² represent a group selected from —O—, >NR²¹, —S—, and >C(═O), and R²¹ represents a hydrogen atom or a substituent,
   X represents ═O, ═S, a carbon atom to which a hydrogen atom or a substituent is bonded, or a nitrogen atom to which a hydrogen atom or a substituent is bonded,
   A^{x} represents an organic group having 1 to 30 carbon atoms, which has at least one aromatic ring selected from an aromatic hydrocarbon ring or an aromatic heterocyclic ring, A^{y} represents a hydrogen atom, an alkyl group having 1 to 6 carbon atoms, or an organic group having 1 to 30 carbon atoms, which has at least one aromatic ring selected from an aromatic hydrocarbon ring or an aromatic heterocyclic ring, A^{x} and A^{y} may be bonded to each other to form a ring,
   Q² represents a hydrogen atom or an alkyl group having 1 to 6 carbon atoms, and
   * represents a bonding position with L¹ or L².

<2>

The curable resin composition according to <1>,
in which the hydrogen bonding group included in the structural unit (b2) is at least one of a hydroxy group, a carboxy group, a sulfo group, a phosphoric acid group, a phosphonic acid group, an amino group, a sulfanyl group, an amide group, a urethane group, a urea group, a thiourethane group, a thiourea group, or a sulfonamide group.

<3>

The curable resin composition according to <1> or <2>,
in which the component (B) is a vinyl polymer.

<4>

The curable resin composition according to <3>,
in which the component (B) is a vinyl polymer which has a structural unit represented by General Formula (p1) as the structural unit (b1) and a structural unit represented by General Formula (p2) as the structural unit (b2),

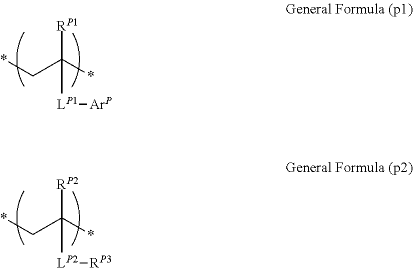

in the formulae, R^{P1} and R^{P2} represent a hydrogen atom or a methyl group, L^{P1} and L^{P2} represent a single bond or a divalent linking group, Ar^{P} represents an aromatic hydrocarbon group which may have a substituent or an aromatic heterocyclic group which may have a substituent, R^{P3} represents a monovalent substituent,
where at least one of L^{P2} or R^{P3} includes at least one group of a hydroxy group, a carboxy group, a sulfo group, a phosphoric acid group, a phosphonic acid group, an amino group, a sulfanyl group, an amide group, a urethane group, a urea group, a thiourethane group, a thiourea group, or a sulfonamide group, and the structural unit represented by General Formula (p1) has no hydrogen bonding group, and
* represents a bonding site for incorporation into a polymer.

<5>

The curable resin composition according to any one of <1> to <4>,
in which Ar is the aromatic ring group represented by General Formula (2-2).

<6>

The curable resin composition according to any one of <1> to <5>,
in which L¹ and L² are —O—, Sp^{a} is a linking group in which a smallest number of atoms which links Pol¹ and L¹ is 11 to 30, and Sp^{b} is a linking group in which a smallest number of atoms which links Pol² and L² is 11 to 30.

<7>

A cemented lens comprising, in the following order:
a lens A;
an adhesive layer; and a lens B,
in which the adhesive layer is a layer consisting of a cured product of the curable resin composition according to any one of <1> to <6>.

<8>

The cemented lens according to <7>,
in which at least one of the lens A or the lens B is a glass lens.

In the present invention, in a case of a plurality of substituents, linking groups, and the like (hereinafter, referred to as a substituent and the like) represented by a specific reference or formula, or in a case of simultaneously defining a plurality of the substituent and the like, unless otherwise specified, the substituent and the like may be the same or different from each other (regardless of the presence or absence of an expression “each independently”, the substituent and the like may be the same or different from each other). The same applies to the definition of the number of substituents and the like. In a case where a plurality of substituents and the like are near (particularly, adjacent to each other), unless otherwise specified, the substituents and the like may be linked to each other to form a ring. In addition, unless otherwise specified, a ring, for example, an alicyclic ring, an aromatic ring, or a heterocyclic ring may be further condensed to form a fused ring.

In the present invention, unless otherwise specified, with regard to a double bond, in a case where E-form and Z-form are present in the molecule, the double bond may be any one of these forms, or may be a mixture thereof.

In addition, in the present invention, unless otherwise specified, in a case where a compound has one or two or more asymmetric carbons, for such stereochemistry of asymmetric carbons, either an (R)-form or an (S)-form can be independently taken. As a result, the compound may be a mixture of optical isomers or stereoisomers such as diastereoisomers, or may be racemic.

In addition, in the present invention, the expression of the compound means that a compound having a partially changed structure is included within a range which does not impair the effects of the present invention. Further, a compound which is not specifically described as substituted or unsubstituted may have an optional substituent within a range which does not impair the effects of the present invention.

In the present invention, with regard to a substituent (the same applies to a linking group and a ring) in which whether it is substituted or unsubstituted is not specified, within a range not impairing the desired effect, it means that the group may have an optional substituent. For example, “alkyl group” means to include both an unsubstituted alkyl group and a substituted alkyl group.

In the present invention, in a case where the number of carbon atoms in a certain group is specified, the number of carbon atoms means the number of carbon atoms in the entire group, unless otherwise specified in the present invention or the present specification. That is, in a case of a form in which the group has a substituent, it means the total number of carbon atoms including the substituent.

In the present invention, a numerical range represented by using “to” means a range including numerical values described before and after “to” as a lower limit value and an upper limit value.

In the present invention, each component may be used alone or in combination of two or more thereof.

In a description of a content of each component in the curable resin composition according to the aspect of the present invention, a solid content in the curable resin composition according to the aspect of the present invention means, in addition to the compound represented by General Formula (1), components remaining in the cured product obtained from the curable resin composition according to the aspect of the present invention. Usually, a remainder after removing a solvent is the “solid content”.

In the present invention, “(meth)acrylate” represents either one or both of acrylate and methacrylate, and “(meth)acryloyl” represents either one or both of acryloyl and methacryloyl. The monomer in the present invention is distinguished from an oligomer and a polymer, and refers to a compound having a weight-average molecular weight of 1,000 or less.

In the present invention, the term aliphatic hydrocarbon group represents a group obtained by removing one optional hydrogen atom from a linear or branched alkane, a linear or branched alkene, or a linear or branched alkyne. In the present invention, the aliphatic hydrocarbon group is preferably an alkyl group obtained by removing one optional hydrogen atom from a linear or branched alkane. Examples of the alkyl group include a methyl group, an ethyl group, a propyl group, an isopropyl group, a butyl group, an isobutyl group, a sec-butyl group, a tert-butyl group, a pentyl group, a 1-methylbutyl group, a 3-methylbutyl group, a hexyl group, a 1-methylpentyl group, a 4-methylpentyl group, a heptyl group, a 1-methylhexyl group, a 5-methylhexyl group, a 2-ethylhexyl group, an octyl group, a 1-methylheptyl group, a nonyl group, a 1-methyloctyl group, a decyl group, an undecyl group, a dodecyl group, a tridecyl group, a tetradecyl group, a pentadecyl group, a hexadecyl group, a heptadecyl group, an octadecyl group, a nonadecyl group, and an eicosyl group.

In addition, in the present invention, the aliphatic hydrocarbon group (unsubstituted) is preferably an alkyl group having 1 to 30 carbon atoms, more preferably an alkyl group having 1 to 12 carbon atoms, still more preferably an alkyl group having 1 to 4 carbon atoms, and particularly preferably a methyl group or an ethyl group.

In the present invention, the term alkyl group represents a linear or branched alkyl group. Examples of the alkyl group include the above-described examples. The same applies to an alkyl group in a group (an alkoxy group, an alkoxycarbonyl group, an acyl group, an acyloxy group, a silyl group substituted with an alkoxy group (alkoxysilyl group), and the like) including the alkyl group.

In addition, in the present invention, examples of an alkylene group include a group obtained by removing one arbitrary hydrogen atom from the above-described alkyl groups, and examples of a linear alkylene group include a group obtained by removing one hydrogen atom bonded to a terminal carbon atom from a linear alkyl group among the above-described alkyl groups.

In the present invention, the term alicyclic hydrocarbon ring means a saturated hydrocarbon ring (cycloalkane). Examples of the alicyclic hydrocarbon ring include cyclopropane, cyclobutane, cyclopentane, cyclohexane, cycloheptane, cyclooctane, cyclononane, and cyclodecane.

In the present invention, the term unsaturated hydrocarbon ring means a hydrocarbon ring having a carbon-carbon unsaturated double bond, which is not an aromatic ring. Examples of the unsaturated hydrocarbon ring include indene, indane, and fluorene.

In the present invention, the term alicyclic hydrocarbon group means a cycloalkyl group obtained by removing one optional hydrogen atom from a cycloalkane. Examples of the alicyclic hydrocarbon group include a cyclopropyl group, a cyclobutyl group, a cyclopentyl group, a cyclohexyl group, a cycloheptyl group, a cyclooctyl group, a cyclononyl group, and a cyclodecyl group, and a cycloalkyl group having 3 to 12 carbon atoms is preferable. In the present invention, a cycloalkylene group refers to a divalent group obtained by removing two optional hydrogen atoms from a cycloalkane. Examples of the cycloalkylene group include a cyclohexylene group.

In the present invention, the term aromatic ring means either one or both of an aromatic hydrocarbon ring and an aromatic heterocyclic ring.

In the present invention, the term aromatic hydrocarbon ring means an aromatic ring in which a ring is formed only by carbon atoms. The aromatic hydrocarbon ring may be a monocyclic ring or a fused ring. An aromatic hydrocarbon ring having 6 to 14 carbon atoms is preferable. Examples of aromatic hydrocarbon rings include a benzene ring, a naphthalene ring, an anthracene ring, a phenanthrene ring, and the like. In the present invention, in a case where the aromatic hydrocarbon ring is bonded to another ring, it is sufficient that the aromatic hydrocarbon ring may be substituted on another ring as a monovalent or divalent aromatic hydrocarbon group.

In the present invention, in a case where a monovalent group is referred to as an aromatic hydrocarbon group, it indicates a monovalent group obtained by removing any one hydrogen atom from an aromatic hydrocarbon ring. As the monovalent aromatic hydrocarbon group is preferably an aromatic hydrocarbon group having 6 to 14 carbon atoms, and examples thereof include a phenyl group, an 1-naphthyl groups, a 2-naphthyl groups, an 1-anthracenyl group, a 2-anthracenyl group, a 9-anthracenyl group, an 1-phenanthryl group, a 2-phenanthryl group, a 3-phenanthryl group, a 4-phenanthryl group, and a 9-phenanthryl group. Among these, a phenyl group is preferable.

In the present invention, in a case where a divalent group is referred to as an aromatic hydrocarbon group, it indicates a divalent group obtained by removing any one hydrogen atom from the above-described monovalent aromatic hydrocarbon group. Examples of the divalent aromatic hydrocarbon group include a phenylene group, a naphthylene group, and a phenanthrylene group, and a phenylene group is preferable and a 1,4-phenylene group is more preferable.

In the present invention, an aromatic heterocyclic ring means an aromatic ring in which a ring is formed by a carbon atom and a heteroatom. Examples of the heteroatom include an oxygen atom, a nitrogen atom, and a sulfur atom. The aromatic heterocyclic ring may be a monocyclic ring or a fused ring, and the number of atoms constituting the ring is preferably 5 to 20 and more preferably 5 to 14. Each ring constituting the aromatic heterocyclic ring is preferably a 5- or 6-membered ring. The number of heteroatoms in the atoms constituting the ring is not particularly limited, but is preferably 1 to 3 and more preferably 1 or 2. Examples of the aromatic heterocyclic ring include a furan ring, a thiophene ring, a pyrrole ring, an imidazole ring, an isothiazole ring, an isoxazole ring, a pyridine ring, a pyrazine ring, a quinoline ring, a benzofuran ring, a benzothiazole ring, a benzoxazole ring, and examples of nitrogen-containing fused aromatic ring, which will be described later. In the present invention, in a case where the aromatic heterocyclic ring is bonded to another ring, it is sufficient that the aromatic heterocyclic ring may be substituted on another ring as a monovalent or divalent aromatic heterocyclic group.

In the present invention, in a case where a monovalent group is referred to as an aromatic heterocyclic group, it indicates a monovalent group obtained by removing any one hydrogen atom from an aromatic heterocyclic ring. Examples of the monovalent aromatic heterocyclic group include a furyl group, a thienyl group, a pyrrolyl group, an imidazolyl group, an isothiazolyl group, an isooxazolyl group, a pyridyl group, a pyrazinyl group, a quinolyl group, a benzofuranyl group (preferably, a 2-benzofuranyl group), a benzothiazolyl group (preferably, a 2-benzothiazolyl group), and a benzoxazolyl group (preferably, a 2-benzoxazolyl group). Among these, a furyl group, a thienyl group, a benzofuranyl group, a benzothiazolyl group, or a benzoxazolyl group is preferable, and a 2-furyl group or a 2-thienyl group is more preferable.

In the present invention, the term divalent aromatic heterocyclic group refers to a divalent group obtained by removing two optional hydrogen atoms from the aromatic heterocyclic ring, and examples thereof include a divalent group obtained by removing one optional hydrogen atom from the above-described (monovalent) aromatic heterocyclic group.

In the present invention, examples of a halogen atom include a fluorine atom, a chlorine atom, a bromine atom, and an iodine atom.

With the curable resin composition according to the aspect of the present invention, a cured product obtained by a curing reaction has excellent adhesiveness to a glass substrate and also has excellent transmittance. Therefore, the cemented lens according to the aspect of the present invention, which includes the cured product as a constituent member, has excellent transmittance and has excellent adhesiveness between lenses bonded by the cured product.

### BRIEF DESCRIPTION OF THE DRAWINGS

FIG. 1 is a schematic view showing an example of a lens optical system including an adhesive layer formed from the curable resin composition according to the embodiment of the present invention.

### DESCRIPTION OF THE PREFERRED EMBODIMENTS

The present invention will be described in detail. The description of configuration requirements described below may be based on representative embodiments, specific examples, and the like, but the present invention is not limited to those embodiments except as specified in the present invention.

[Curable Resin Composition]

The curable resin composition according to the embodiment of the present invention is a curable resin composition containing the following component (A) and the following component (B).

Component (A): a compound represented by General Formula (1) described later.

Component (B): a polymer including a structural unit (b1) having an aromatic ring and a structural unit (b2) having a hydrogen bonding group, in which a proportion of the structural unit (b1) in all structural units constituting the polymer is 10% by mass or more and a proportion of the structural unit (b2) in all structural units constituting the polymer is 3% by mass or more.

However, the above-described structural unit (b1) has no hydrogen bonding group.

The curable resin composition according to the embodiment of the present invention contains a component (A): a compound represented by General Formula (1) and a component (B): a specific polymer. The polymer of the component (B) has a specific chemical structure that includes a structural unit (b1) having an aromatic ring, which exhibits high affinity for Ar (hereinafter, abbreviated as “aromatic ring Ar”) included in the compound represented by General Formula (1), and a structural unit (b2) having a hydrogen bonding group, which exhibits high affinity for glass in a cemented lens or the like. In the curable resin composition according to the embodiment of the present invention, it is considered that, by using a polymer in which these structural units (b1) and (b2) are controlled to specific amounts, a cured product to be obtained achieves excellent transmittance due to improved compatibility between the component (A) and the component (B), and exhibits excellent adhesiveness to an optical material such as glass (preferably, a glass lens).

<Component (A): Compound Represented by General Formula (1)>

The curable resin composition according to the embodiment of the present invention contains a compound represented by General Formula (1).

Pol¹-Sp^{a}-L¹-Ar-L²-Sp^{b}-Pol² General Formula (1)

In the formula, Ar represents an aromatic ring group represented by any of General Formula (2-1), . . . , or (2-4),
L¹ and L² represent a single bond, —O—, —S—, —C(═O)—, —OC(═O)—, —C(═O)O—, —OC(═O)O—, —NR¹⁰¹C(═O)—, —C(═O)NR¹⁰²—, —OC(═O)NR¹⁰³—, —NR¹⁰⁴C(═O)O—, —SC(═O)—, or —C(═O)S—,
R¹⁰¹ to R¹⁰⁴ represent -Sp^{c}-Pol³ or a halogen atom,
Sp^{a} and Sp^{b} represent a single bond, a linear alkylene group having 1 to 30 carbon atoms, which may have a substituent, or a group in which, in a linear alkylene group having 2 to 30 carbon atoms, which may have a substituent, one or two or more —CH₂—'s excluding a linking portion to L¹ or L² are substituted by a group selected from —O—, —S—, >C(═O), or >NR¹¹¹,
R¹¹¹ represents -Sp^{d}-Pol⁴ or a halogen atom,
Sp^{c} and Sp^{d} represent a single bond or a divalent linking group, and
Pol¹ and Pol² represent a polymerizable group, and Pol³ and Pol⁴ represent a hydrogen atom or a polymerizable group.

Hereinafter, Ar, Sp^{a} and Sp^{b}, Pol¹ and Pol², and L¹ and L² will be described in detail.

(1) Ar

Ar is an aromatic ring group represented by any of General Formula (2-1), . . . , or (2-4).

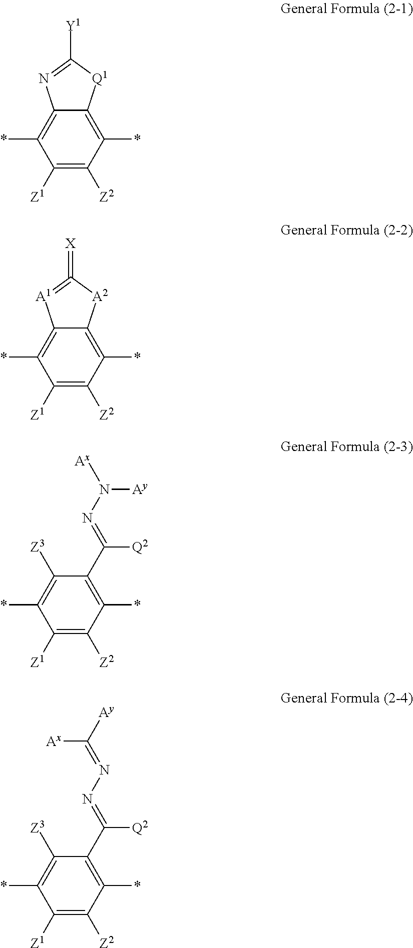

In the formulae, Q¹ represents —S—, —O—, or >NR¹¹, and R¹¹ represents a hydrogen atom or an alkyl group having 1 to 6 carbon atoms,
Y¹ represents an alkyl group having 1 to 6 carbon atoms, an aromatic hydrocarbon group having 6 to 12 carbon atoms, or an aromatic heterocyclic group having 3 to 12 carbon atoms,
Z¹, Z², and Z³ represent a hydrogen atom, an aliphatic hydrocarbon group having 1 to 20 carbon atoms, an alkoxy group having 1 to 20 carbon atoms, an alicyclic hydrocarbon group having 3 to 20 carbon atoms, an aromatic hydrocarbon group having 6 to 20 carbon atoms, a halogen atom, a cyano group, a nitro group, —NR¹²R¹³, or —SR¹², Z¹ and Z² may be bonded to each other to form an aromatic hydrocarbon ring or an aromatic heterocyclic ring, R¹² and R¹³ represent a hydrogen atom or an alkyl group having 1 to 6 carbon atoms,
A¹ and A² represent a group selected from —O—, >NR²¹, —S—, and >C(═O), R²¹ represents a hydrogen atom or a substituent, in which a hydrogen atom or an alkyl group having 1 to 6 carbon atoms is preferable,
X represents ═O (oxygen atom), ═S (sulfur atom), a carbon atom to which a hydrogen atom or a substituent is bonded, or a nitrogen atom to which a hydrogen atom or a substituent is bonded,
A^{x} represents an organic group having 1 to 30 carbon atoms, which has at least one aromatic ring selected from an aromatic hydrocarbon ring or an aromatic heterocyclic ring, A^{y} represents a hydrogen atom, an alkyl group having 1 to 6 carbon atoms, or an organic group having 1 to 30 carbon atoms, which has at least one aromatic ring selected from an aromatic hydrocarbon ring or an aromatic heterocyclic ring, A^{x} and A^{y} may be bonded to each other to form a ring,
Q² represents a hydrogen atom or an alkyl group having 1 to 6 carbon atoms, and
* represents a bonding position with L¹ or L².

With regard to the definition and preferred range of each substituent in General Formulae (2-1) to (2-4), unless otherwise noted, the descriptions regarding Y¹, Q¹, and Q² in the compound (A) described in JP2012-21068A can be adopted as they are to Y¹, Z¹, and Z², the descriptions regarding A₁, A₂, and X in the compound represented by General Formula (I) described in JP2008-107767A can be adopted as they are to A¹, A², and X in General Formula (2-2), the descriptions regarding A^{x}, A^{y}, and Q¹ in the compound represented by General Formula (I) described in WO2013/018526A can be adopted as they are to A^{x}, A^{y}, and Q² in General Formula (2-3), and the descriptions regarding A^{a}, A^{b}, and Q¹¹ in the compound represented by General Formula (II) described in WO2013/018526A can be adopted as they are to A^{x}, A^{y}, and Q² in General Formula (2-4). The description regarding Q¹ in the compound (A) described in JP2012-21068A can be adopted as they are to Z³.

Q¹ in General Formula (2-1) is preferably —S—. X in General Formula (2-2) is preferably a carbon atom to which two substituents are bonded, and both A¹ and A² are preferably —S—. In General Formula (2-3), as the ring in a case where A^{x} and A^{y} are bonded to each other to form a ring, an alicyclic hydrocarbon ring, an aromatic hydrocarbon ring, or an aromatic heterocyclic ring is preferable, and an aromatic heterocyclic ring is more preferable. In General Formula (2-4), as the ring in a case where A^{x} and A^{y} are bonded to each other to form a ring, an unsaturated hydrocarbon ring is preferable.

From the viewpoint of further improving moisture-heat resistance and transmittance, Ar in General Formula (1) is preferably the aromatic ring group represented by General Formula (2-2).

As the aromatic ring group represented by General Formula (2-2), an aromatic ring group represented by General Formula (2-21) is preferable.

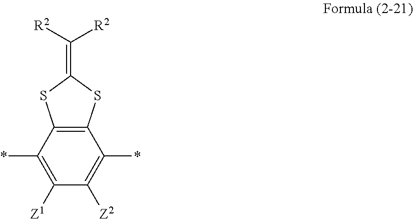

In the formula, R^{z} represents a substituent, and Z¹ and Z² have the same meaning as Z¹ and Z² in General Formula (2-2), respectively.

Examples of the substituent represented by R^{z} include substituents which may be included in a linear alkylene group in Sp^{a} and Sp^{b}, which will be described later, and preferred examples thereof include an alkyl group, an alkoxy group, an alkoxycarbonyl group, a halogen atom, and a cyano group. Two R^{z}'s may be the same or different from each other.

In addition, two R^{z}'s may be bonded to each other to form a ring, and in this case, the ring to be formed is preferably a 5-membered ring or a 6-membered ring, and more preferably includes a nitrogen atom or an oxygen atom as an atom constituting the ring. The ring formed by bonding two R^{z}'s to each other is more preferably a ring represented by any of the following structures.

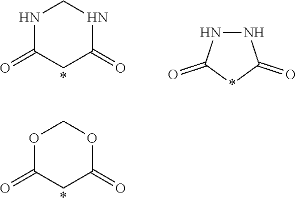 [SMILES: O=C1CC(=O)NCN1 ; O=c1*c(=O)[nH][nH]1 ; O=C1CC(=O)OCO1]

In the above formulae, * represents a position of a carbon atom where the two R^{z}'s are bonded in General Formula (2-21), respectively. As the substituent in this case, an alkyl group having 1 to 6 carbon atoms is preferable, and a linear alkyl group having 1 to 4 carbon atoms is more preferable.

As the aromatic ring group represented by General Formula (2-21), an aromatic ring group in which at least one of R^{z}'s is a cyano group or an aromatic ring group in which two R^{z}'s are bonded to each other to form a ring is preferable, and an aromatic ring group represented by General Formula (2-21a), in which two R^{z}'s are cyano groups, is more preferable.

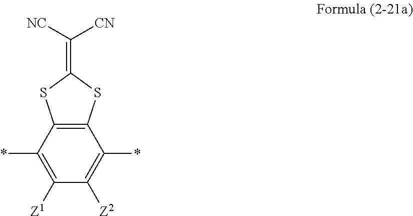

In the formula, Z¹ and Z² have the same meaning as Z¹ and Z² in General Formula (2-2), respectively.

(2) Sp^{a} and Sp^{b}

Sp^{a} and Sp^{b} represent a single bond, a linear alkylene group having 1 to 30 carbon atoms, which may have a substituent, or a group in which, in a linear alkylene group having 2 to 30 carbon atoms, which may have a substituent, one or two or more —CH₂—'s excluding a linking portion to L¹ or L² are substituted by a group selected from —O—, —S—, >C(═O), or >NR¹¹¹.

R¹¹¹ represents —Sp^{d}-Pol⁴ or a halogen atom. Sp^{d} represents a single bond or a divalent linking group, and Pol⁴ represents a hydrogen atom or a polymerizable group. As Sp^{d} and Pol⁴, the description of Sp^{c} and Pol³ described later can be adopted, respectively.

However, a linking portion of Sp^{a} to L¹ and a linking portion of Sp^{b} to L² are both —CH₂—, and a linking portion of Sp^{a} to Pol¹ and a linking portion of Sp^{b} to Pol² are both a carbon atom. The regulation of these linking portions also applies to the following descriptions relating to Sp^{a} and Sp^{b}.

The carbon atoms in “linear alkylene group having 1 to 30 carbon atoms” and “linear alkylene group having 2 to 30 carbon atoms” described above mean the number of carbon atoms in a state without a substituent, which have the same meaning as the smallest number of atoms in Sp^{a}, which links Pol¹ and L¹, and have the same meaning as the smallest number of atoms in Sp^{b}, which links Pol² and L². Therefore, as the carbon atoms in the linear alkylene group having 1 to 30 carbon atoms and in the linear alkylene group having 2 to 30 carbon atoms, the preferred carbon atoms with the smallest number of atoms described below can be adopted. In this regard, in a case where the “linear alkylene group having 1 to 30 carbon atoms” has a substituent, an alkyl group can also be taken as the substituent. In this case, the alkylene group is a branched alkylene group as a whole, but a linear moiety consisting of “smallest number of atoms” of “smallest number of atoms of 1 or more” in Sp^{a} and Sp^{b} corresponds to the “linear alkylene group having 1 to 30 carbon atoms”. The same also applies to the “linear alkylene group having 2 to 30 carbon atoms”.

In the example of -L²-Sp^{b}-Pol² shown below, the smallest number of atoms linking —O— as L² and a methacryloyloxy group as Pol² is 10.

The above-described smallest number of atoms is preferably 2 to 30, more preferably 11 to 30, still more preferably 11 to 25, particularly preferably 12 to 25, and most preferably 12 to 20.

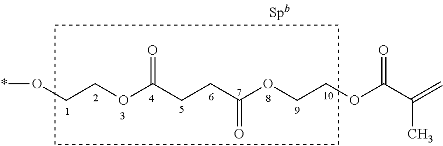 [SMILES: *OCCOC(=O)CCC(=O)OCCOC(=O)C(=C)C]

Examples of the substituent which may be included in the linear alkylene group of Sp^{a} and Sp^{b} described above include an alkyl group, a cycloalkyl group, an alkoxy group, an acyl group, an acyloxy group, an alkoxycarbonyl group, an amide group, an amino group, a halogen atom, a nitro group, and a cyano group, and an alkyl group is preferable, an alkyl group having 1 to 3 carbon atoms is more preferable, and a methyl group is still more preferable.

The number of substituents is not particularly limited, and for example, may be 1 to 4.

The above-described substitution of one or two or more —CH₂—'s, excluding the linking portion to L¹ or L² by the group selected from —O—, —S—, >C(═O), and >NR¹¹¹ is not particularly limited in the number, type, and the like of the substitution as long as the substitution can function as the linking group.

Specific examples of the above-described substitution are shown below.

“Substitution of —CH₂—”:

Examples thereof include a substitution of —CH₂— by —O—, —S—, >C(═O), or >NR¹¹¹, and a substitution by —O— or >C(═O) is preferable, and a substitution by —O— is more preferable.

“Substitution of —CH₂CH₂—”:

Examples thereof include a substitution of —CH₂CH₂— by —C(═O)O—, —NR¹¹¹C(═O)—, or —SC(═O)—, and a substitution by —C(═O)O— or —NR¹¹¹C(═O)— is preferable, and a substitution by —C(═O)O— is more preferable.

“Substitution of —CH₂CH₂CH₂—”:

Examples thereof include a substitution of —CH₂CH₂CH₂— by —OC(═O)O—, —NR¹¹¹C(═O)O—, and a substitution by —OC(═O)O— is preferable.

The above-described substitution by —C(═O)O—, —NR¹¹¹C(═O)—, —NR¹¹¹C(═O)O—, or —SC(═O)— may be substituted in a form such that either the left or right bonding site is located on the L¹ side or the L² side.

It is preferable that Sp^{a} and Sp^{b} are the above-described divalent linking group, that is, a linear alkylene group having 1 to 30 carbon atoms or a group in which, in a linear alkylene group having 2 to 30 carbon atoms, one or two or more —CH₂—'s excluding a linking portion to L¹ or L² are substituted by a group selected from —O—, —S—, >C(═O), or >NR¹¹¹; it is more preferable that Sp^{a} and Sp^{b} are a linear alkylene group having 2 to 30 carbon atoms or a group in which, in a linear alkylene group having 2 to 30 carbon atoms, one or two or more —CH₂—'s excluding a linking portion to L¹ or L² are substituted by a group selected from —O— or >C(═O); from the viewpoint of further improving the adhesiveness of the cured product, it is still more preferable that Sp^{a} and Sp^{b} are a linear alkylene group having 11 to 30 carbon atoms or a group in which, in a linear alkylene group having 11 to 30 carbon atoms, one or two or more —CH₂CH₂—'s excluding a linking portion to L¹ or L² are substituted by a group selected from —C(═O)O— or —OC(═O)—; and from the viewpoint of further improving the moisture-heat resistance of the cured product, it is still more preferable that Sp^{a} and Sp^{b} are a linear alkylene group having 12 to 25 carbon atoms or a group in which, in a linear alkylene group having 12 to 25 carbon atoms, one or two or more —CH₂CH₂—'s excluding a linking portion to L¹ or L² are substituted by a group selected from —C(═O)O— or —OC(═O)—.

Sp^{a} and Sp^{b} may be the same or different from each other, but it is preferable that Sp^{a} and Sp^{b} are the same.

(3) Pol¹ and Pol²

Pol¹ and Pol² represent a polymerizable group.

The polymerizable group may be a group including any of a vinylidene structure, an oxirane structure, or an oxetane structure. From the viewpoint of convenience in synthesizing the compound represented by General Formula (1), the polymerizable group is preferably a group in which the linking part to Sp^{a} or Sp^{b} is an oxygen atom and which includes any of a vinylidene structure, an oxyrane structure, or an oxetane structure, and examples thereof include polymerizable groups represented by any of Formulae (Pol-1) to (Pol-6).

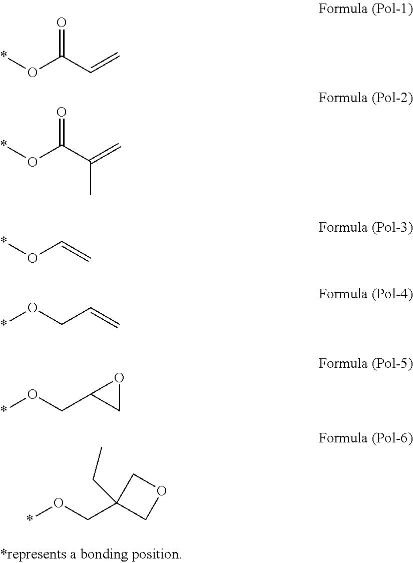

Among these, a (meth)acryloyloxy group represented by Formula (Pol-1) or Formula (Pol-2) is preferable, and a methacryloyloxy group represented by Formula (Pol-2) is more preferable.

It is preferable that any one of Pol¹ or Pol² is a (meth)acryloyloxy group, and it is more preferable that the both are (meth)acryloyloxy groups.

Pol¹ and Pol may be the same or different from each other, but it is preferable that Pol¹ and Pol are the same.

Examples of a specific structure of Pol¹-Sp^{a}-L¹- or Pol²-Sp^{b}-L²- include the following structures. In the following structural formulae, R is a hydrogen atom or a methyl group, and * represents a bonding position with Ar.

In addition, a structure of Pol¹-Sp^{a}-L¹- or Pol²-Sp^{b}-L²-, which is described later in a specific example of the compound represented by General Formula (1), can also be mentioned. Pol¹-Sp^{a}-L¹- and Pol²-Sp^{b}-L²- may be the same or different from each other, but it is preferable that Pol¹-Sp^{a}-L¹- and Pol²-Sp^{b}-L²- are the same.

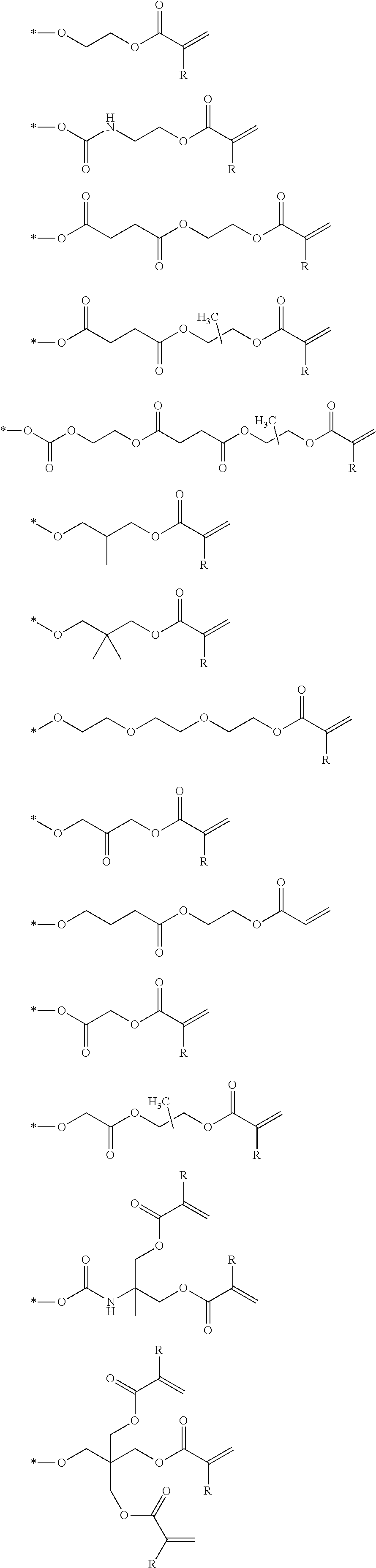

In the present invention, the structure represented by the following notation indicates an isopropylene structure. This isopropylene structure may be any of two structural isomers in which a methyl group is bonded to one of carbons constituting an ethylene group, and these structural isomers may be mixed.

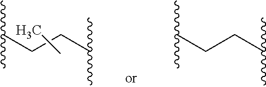

As described above, in the compound represented by General Formula (1), in a case where a linear alkylene group has a structure in which a substituent is substituted, structural isomers having different substitution positions of the substituent may exist. The compound represented by General Formula (1) may be a mixture of such structural isomers.

(4) L¹ and L²

L¹ and L² represent a single bond, —O—, —S—, —C(═O)—, —OC(═O)—, —C(═O)O—, —OC(═O)O—, —NR¹⁰¹C(═O)—, —C(═O)NR¹⁰²—, —OC(═O)NR¹⁰³—, —NR¹⁰⁴C(═O)O—, —SC(═O)—, or C(═O)S—. In the above description of the linking group, it is assumed that the left side is bonded to Ar and the right side is bonded to Sp^{a} or Sp^{b}. The same applies to the following description relating to L¹ and L².

R¹⁰¹ to R¹⁰⁴ represent —Sp^{c}-Pol³ or a halogen atom. Sp^{c} represents a single bond or a divalent linking group, and Pol³ represents a hydrogen atom or a polymerizable group.

Examples of the divalent linking group which can be adopted as Sp^{c} include the following linking groups and linking groups consisting of two or more of the following linking groups: linear alkylene groups; cycloalkylene groups (for example, a trans-1,4-cyclohexylene group); divalent aromatic hydrocarbon groups (for example, a 1,4-phenylene group); divalent aromatic heterocyclic groups; —O—; —S—; —C(═O)—; —OC(═O)—; —C(═O)O—; —OC(═O)O—; —NR²⁰¹C(═O)—; —C(═O)NR²⁰²—; —OC(═O)NR²⁰³—; —NR²⁰⁴C(═O)O—; —SC(═O)—; and —C(═O)S—. Examples of Sp^{c} which is a divalent linking group include a linear alkylene group, a cycloalkylene group, a divalent aromatic hydrocarbon group, and a divalent aromatic heterocyclic group. In addition, examples thereof also include linking groups in which two or more linking groups selected from the linear alkylene group, the cycloalkylene group, the divalent aromatic hydrocarbon group, and the divalent aromatic heterocyclic group are bonded to each other through a linking group selected from a single bond, —O—, —C(═O)—, —OC(═O)—, —C(═O)O—, —OC(═O)O—, —NR²⁰¹C(═O)—, and C(═O)NR²⁰²—.

R²⁰¹ to R²⁰⁴ represent a hydrogen atom or an alkyl group having 1 to 3 carbon atoms.

As the divalent linking group represented by Sp^{c}, a single bond or a linear alkylene group having 1 to 10 carbon atoms is preferable, a linear alkylene group having 1 to 5 carbon atoms is more preferable, and a linear alkylene group having 1 to 3 carbon atoms is still more preferable. The linear alkylene group which can be adopted as Sp^{c} is preferably an unsubstituted linear alkylene group.

The polymerizable group which can be adopted as Pol³ has the same meaning as the above-described polymerizable group.

Pol³ is preferably a hydrogen atom.

As —Sp^{c}-Pol³, a hydrogen atom or an alkyl group having 1 to 4 carbon atoms is preferable, and a hydrogen atom or an unsubstituted alkyl group having 1 to 4 carbon atoms is more preferable.

L¹ and L² are preferably —O—, —OC(═O)—, —C(═O)O—, —OC(═O)O—, —NR¹⁰¹C(═O)—, —C(═O)NR¹⁰²—, —OC(═O)NR¹⁰³—, or —NR¹⁰⁴C(═O)O—, more preferably —O—, —OC(═O)—, —OC(═O)O—, or —OC(═O)NR¹⁰³—, still more preferably —O— or —OC(═O)—, and particularly preferably —O—.

L¹ and L² may be the same or different from each other, but it is preferable that L¹ and L² are the same.

From the viewpoint of further improving the adhesiveness, in the compound represented by General Formula (1), it is preferable that L¹ and L² are —O—, Sp^{a} is a linking group in which the smallest number of atoms which links Pol¹ and L¹ is 11 to 30, and Sp^{b} is a linking group in which the smallest number of atoms which links Pol² and L² is 11 to 30.

In addition, the compound represented by General Formula (1) is preferably a non-liquid crystalline compound. That is, from the viewpoint of using as a lens material, it is preferable that the Sp^{a} and Sp^{b} are linking groups having no ring structure.

Hereinafter, preferred specific examples of the compound represented by General Formula (1) are listed, but the present invention is not limited to these compounds. In the following structural formulae, Me represents a methyl group, Et represents an ethyl group, nPr represents an n-propyl group, iPr represents an isopropyl group, nBu represents an n-butyl group, and tBu represents a t-butyl group.

In addition, preferred examples of the compound represented by General Formula (1) in the present invention also include compounds described in [0068] to [0074] of WO2019-131572A.

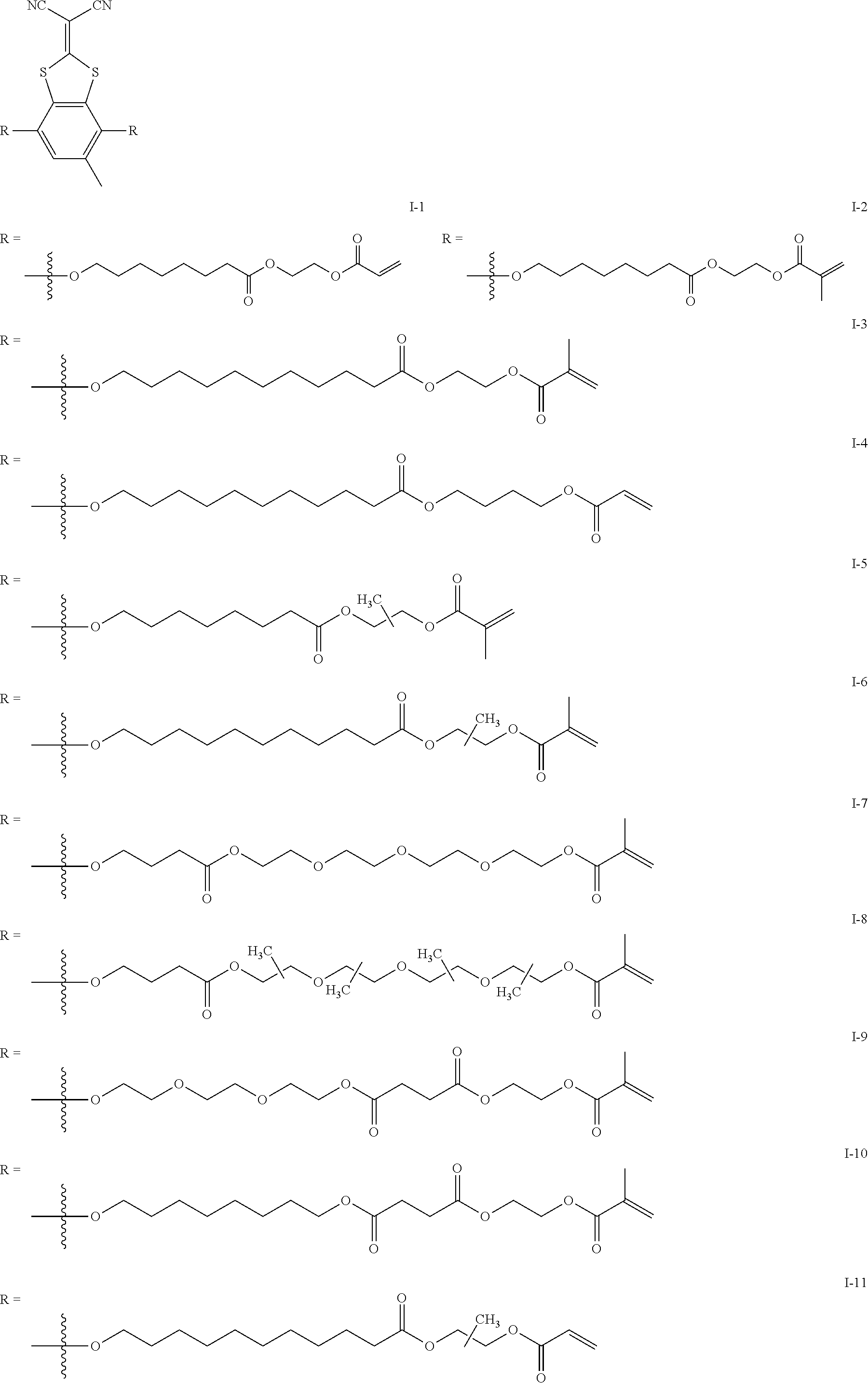

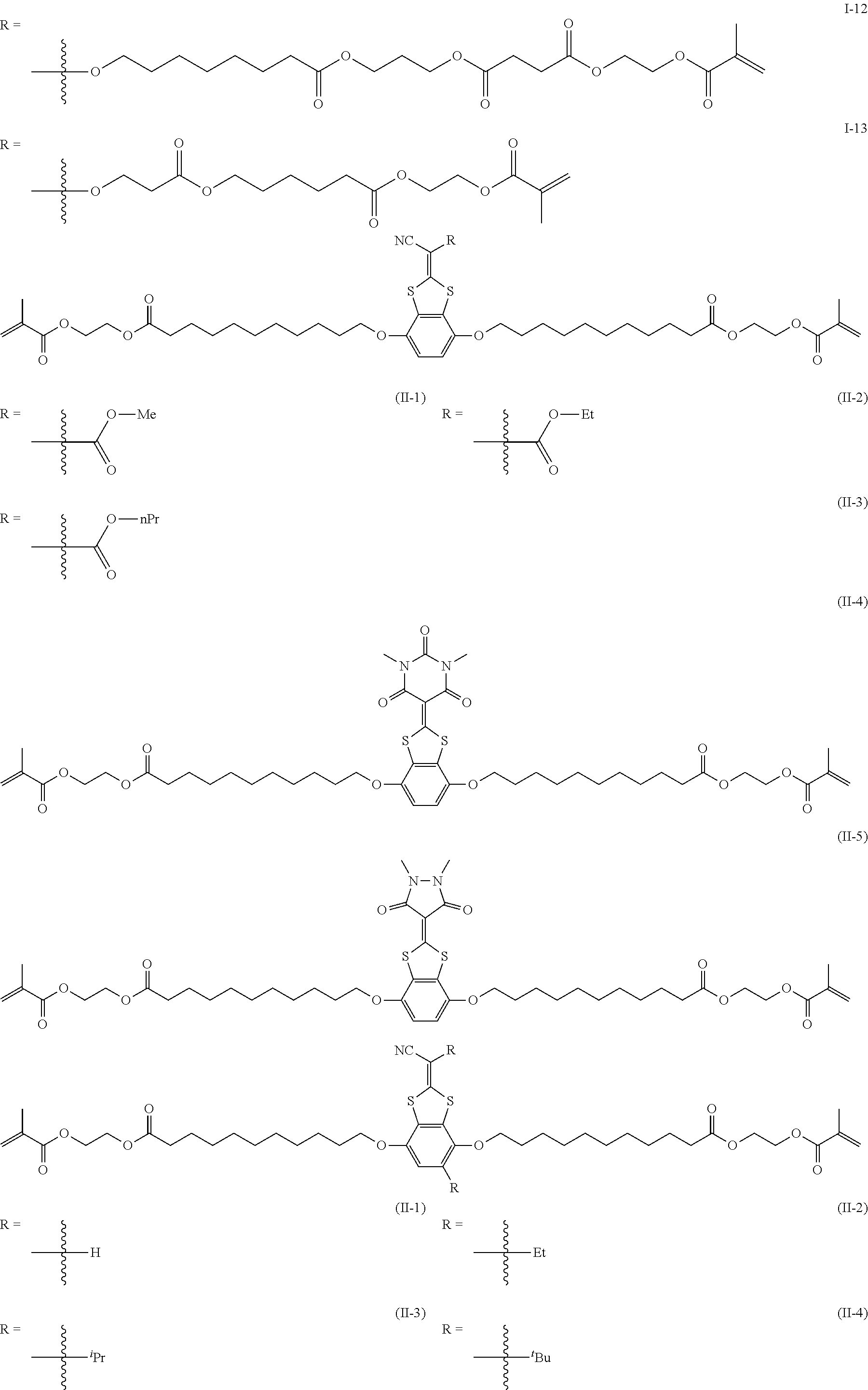

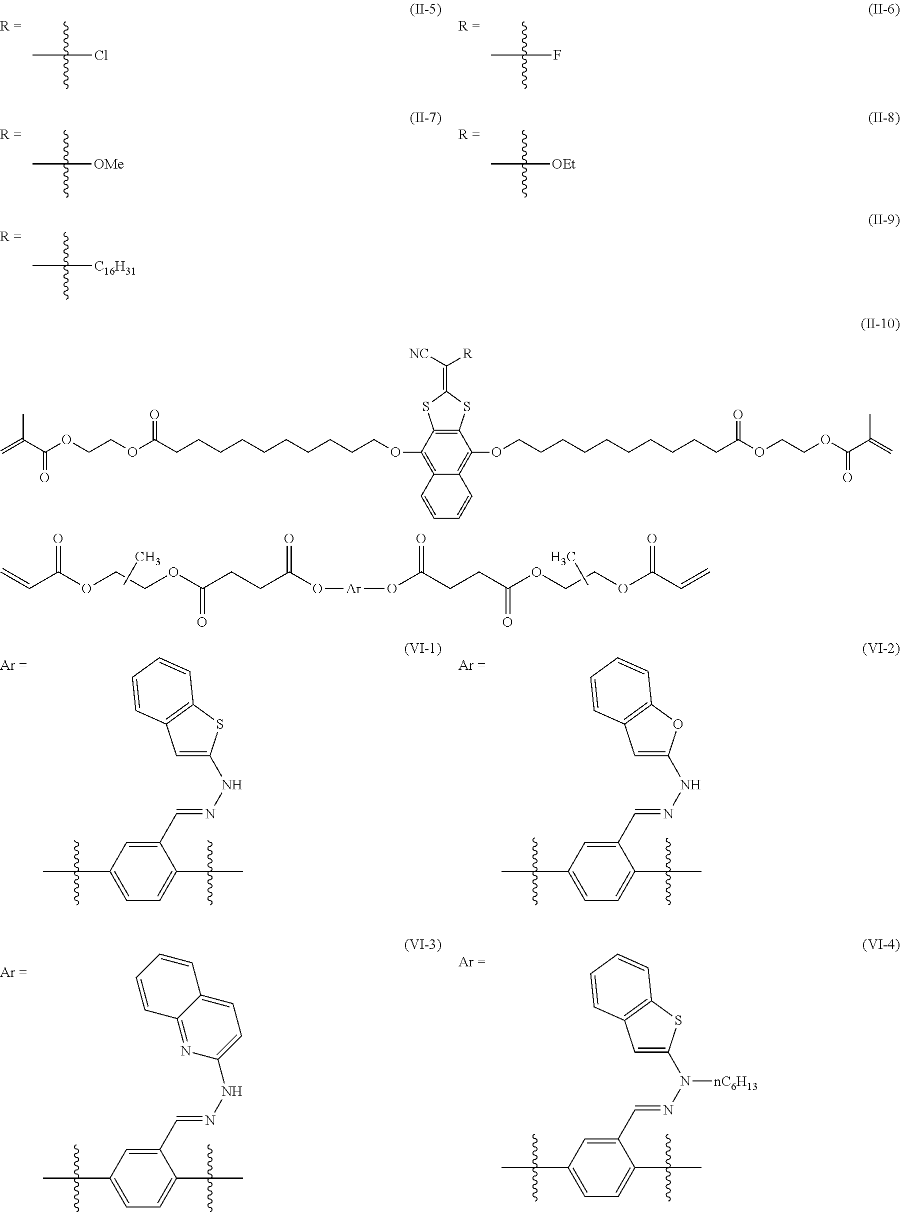

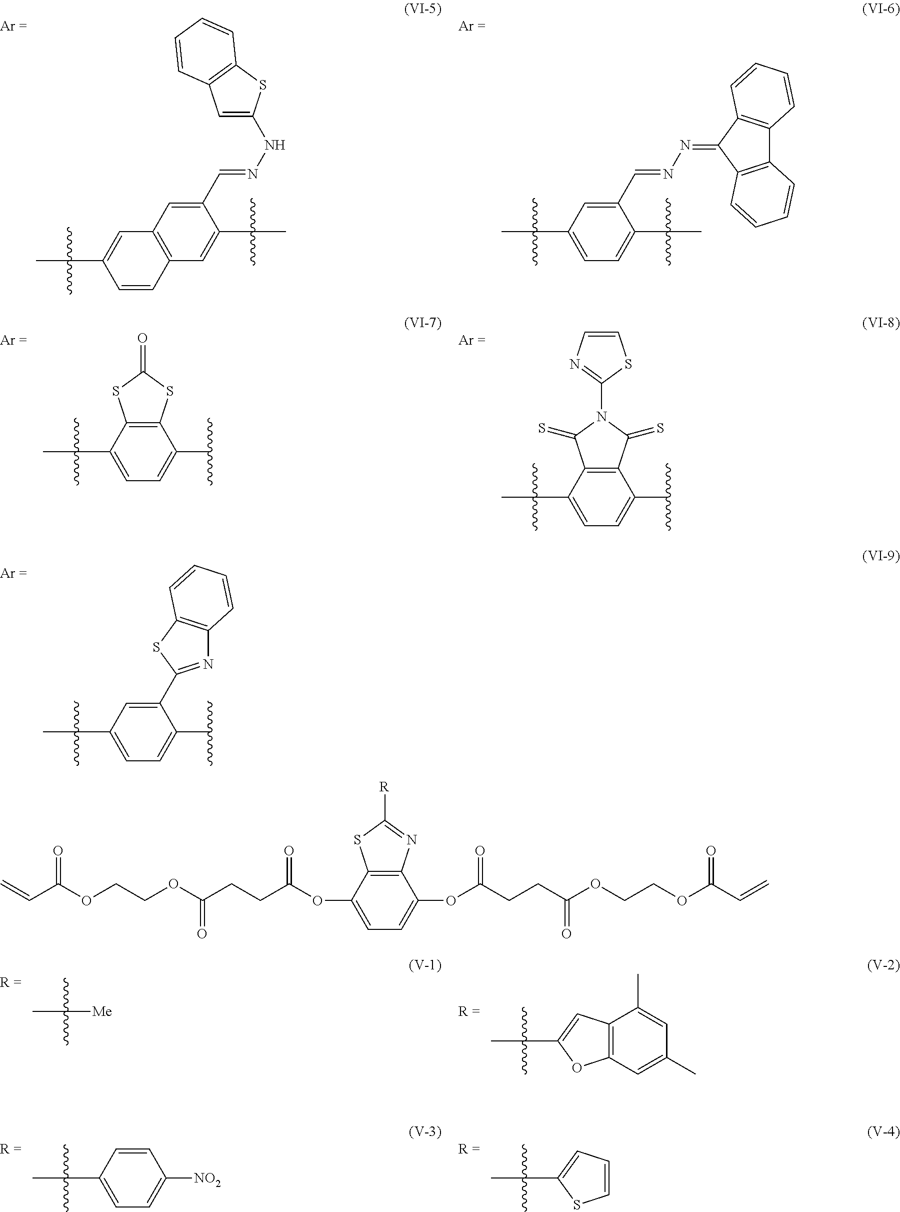

A content of the compound represented by General Formula (1) in the curable resin composition according to the embodiment of the present invention is preferably 10% to 90% by mass, more preferably 15% to 85% by mass, and still more preferably 20% to 80% by mass.

The curable resin composition according to the embodiment of the present invention may contain two or more kinds of the compounds represented by General Formula (1). In a case of containing two or more kinds of the compounds represented by General Formula (1), the total content thereof is preferably within the above-described range.

<Component (B): Polymer>

The curable resin composition according to the embodiment of the present invention contains, as the component (B), a polymer including a structural unit (b1) having an aromatic ring and a structural unit (b2) having a hydrogen bonding group, in which a proportion of the structural unit (b1) in all structural units constituting the polymer is 10% by mass or more and a proportion of the structural unit (b2) in all structural units constituting the polymer is 3% by mass or more.

In the present invention, among structural units included in the polymer of the component (B), the structural unit having a hydrogen bonding group is always classified into the structural unit (b2). That is, the above-described structural unit (b1) does not have a hydrogen bonding group, and a structural unit having both an aromatic ring and a hydrogen bonding group is classified into the above-described structural unit (b2).

The type of the polymer of the component (B) is not particularly limited as long as it is a polymer including the structural unit (b1) having an aromatic ring and the structural unit (b2) having a hydrogen bonding group, a vinyl polymer such as an acrylic polymer, an addition polymer such as polyurethane, a condensation polymer such as polyester and polycarbonate, a ring-opening metathesis polymer using a cyclic olefin monomer, and the like, which are obtained by a chain polymerization of one or two or more kinds of monomers having a carbon-carbon double bond, can be used. Among these, from the viewpoint of further improving the adhesiveness and the moisture-heat resistance, a vinyl polymer is preferable.

(b1) Structural Unit Having Aromatic Ring

The polymer of the above-described component (B) has a structural unit (b1) having an aromatic ring.

Examples of the aromatic ring included in the above-described structural unit (b1) include an aromatic hydrocarbon ring such as a benzene ring, a naphthalene ring, an anthracene ring, and a phenanthrene ring, and an aromatic heterocyclic ring such as a furan ring, a pyrrole ring, a thiophene ring, a pyridine ring, a thiazole ring, a benzothiazole ring, and a phenanthroline ring.

The aromatic ring included in the above-described structural unit (b1) is preferably a benzene ring, a naphthalene ring, or a pyridine ring, and from the viewpoint of further improving the adhesiveness, a benzene ring is more preferable.

It is preferable that the polymer of the above-described component (B) has a structural unit represented by General Formula (p1) as the above-described structural unit (b1).

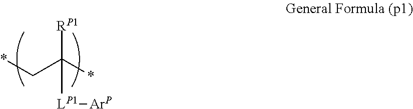

In the formula, R^{P1} represents a hydrogen atom or a methyl group, L^{P1} represents a single bond or a divalent linking group, and Ar^{P} represents an aromatic hydrocarbon group which may have a substituent or an aromatic heterocyclic group which may have a substituent.

However, the structural unit represented by General Formula (p1) has no hydrogen bonding group. That is, L^{P1} does not have a hydrogen bonding group, and Ar^{P} does not have a hydrogen bonding group.

* represents a bonding site for incorporation into a polymer.

In the group represented by -L^{P1}-Ar^{P}, an aromatic hydrocarbon ring or aromatic heterocyclic ring, which is positioned at the most terminal of the longest bonding chain counted from a carbon atom to which R^{P1} is bonded is interpreted as Ar^{P}, and the remainder is interpreted as L^{P1}.

That is, with regard to Ar^{P}, as an aromatic hydrocarbon in the aromatic hydrocarbon group which may have a substituent and an aromatic heterocyclic ring in the aromatic heterocyclic group which may have a substituent, the description of the aromatic hydrocarbon ring and the aromatic heterocyclic ring as the aromatic ring included in the above-described structural unit (b1) can be adopted.

Examples of the substituent which may be included in the aromatic hydrocarbon ring group and the aromatic heterocyclic group in Ar^{P} include an alkyl group, an alkoxy group, an alkoxysilyl group, and an acyloxy group.

L^{P1} represents a single bond or a divalent linking group.

Examples of the divalent linking group which can be adopted as L^{P1} include an alkylene group, a divalent aromatic hydrocarbon group (for example, a 1,4-phenylene group; hereinafter, also referred to as “arylene group”), a divalent aromatic heterocyclic group (hereinafter, also referred to as “heteroarylene group”), a group selected from —O—, >C(═O), or >NR^{b}, and a linking group consisting of a combination of two or more of these groups.

R^{b} is an alkyl group, a monovalent aliphatic or aromatic heterocyclic group, or a monovalent aromatic hydrocarbon ring group.

The alkylene group, arylene group, and heteroarylene group which can form L^{P1} may have a substituent. The substituent which may be included in the alkylene group, arylene group, and heteroarylene group which can form L^{P1} is not particularly limited as long as it is not a hydrogen bonding group, and examples thereof include an alkyl group, a cycloalkyl group, an alkoxy group, an acyl group, an acyloxy group, an alkoxycarbonyl group, an amino group (—N(R^{Y})₂), an amide group (—CON(R^{Y})₂ or —NR′COR′), and a sulfonamide group (—SO₂N(R^{Y})₂ or —NR^{Y}SO₂R^{Y}). R^{Y} is an alkyl group, a monovalent aliphatic or aromatic heterocyclic group, or a monovalent aromatic hydrocarbon ring group.

The number of substituents is not particularly limited, and for example, may be 1 to 4.

Examples of the above-described linking group consisting of a combination of two or more of the groups selected from —O—, >C(═O), or >NR^{b} include —OC(═O)—, —C(═O)O—, —OC(═O)O—, —NR^{b}C(═O)—, —C(═O)NR^{b}—, —OC(═O)NR^{b}—, and —NR^{b}C(═O)O—, and —OC(═O)—, —C(═O)O—, —NR^{b}C(═O)—, or —C(═O)NR^{b}— is preferable. In the above description of the linking group, it is assumed that the left side is bonded to the carbon atom to which R^{P1} is bonded and the right side is bonded to Ar^{P}. The same applies to the followings.

In addition, preferred examples thereof also include a group consisting of a combination of at least one group selected from an alkylene group, an arylene group, or a heteroarylene group, and at least one of a group selected from —O—, >C(═O), or >NR^{b}, or a linking group consisting of a combination of two or more of these groups. Examples thereof include a —C(═O)O-alkylene group. In addition, preferred examples thereof also include a group in which an alkylene group in the —C(═O)O-alkylene group is further combined with —O—, arylene group-O—, —O-arylene group, heteroarylene group-O—, or —O-heteroarylene group.

As L^{P1}, a single bond, a —C(═O)O-alkylene group, or a group in which an alkylene group in the —C(═O)O-alkylene group is further combined with —O—, arylene group-O—, —O-arylene group, heteroarylene group-O—, or —O-heteroarylene group is preferable; a —C(═O)O-alkylene group or a group in which an alkylene group in the —C(═O)O-alkylene group is further combined with —O—, arylene group-O—, or —O-arylene group is more preferable; —C(═O)O-alkylene group or —C(═O)O-alkylene-O— is still more preferable.

Examples of the above-described structural unit represented by General Formula (p1) include the following structural units. However, the above-described structural unit represented by General Formula (p1) is not limited to these structural units.

In the following chemical structural formulae, Me represents a methyl group, and ^{t}Bu represents a tert-butyl group.

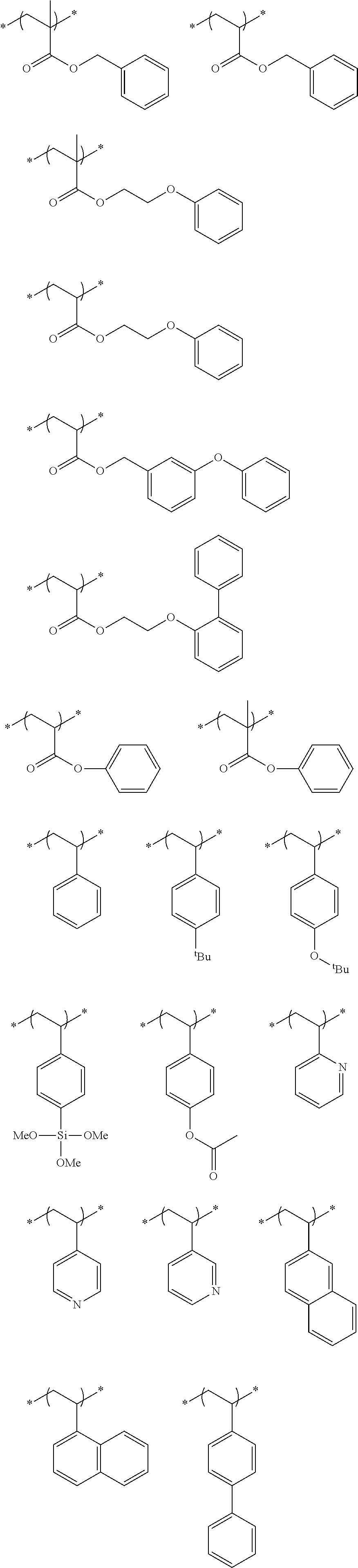

A proportion of the structural unit (b1) having an aromatic ring in all structural units constituting the polymer is preferably 10% to 97% by mass, more preferably 20% to 96% by mass, and from the viewpoint of further improving the transmittance, 30% to 95% by mass is particularly preferable.

In a case where the polymer of the component (B) has a structural unit other than the structural units (b1) and (b2) (other structural units), a proportion of the structural unit (b1) having an aromatic ring in all structural units constituting the polymer is preferably 10% to 80% by mass, more preferably 20% to 80% by mass, and still more preferably 30% to 75% by mass.

The proportion of the structural unit (b1) having an aromatic ring and the proportion of the structural unit (b2) having a hydrogen bonding group in all structural units constituting the polymer can be obtained by, determining a component corresponding to the structural unit (b1) having an aromatic ring in monomer components used to obtain the polymer, determining a component corresponding to the structural unit (b2) having a hydrogen bonding group in the remaining monomer components, and then calculating the proportions based on mass ratios of these components. For example, in a case of polyurethane synthesized by an addition polymerization of a bifunctional isocyanato compound (A1) having an aromatic ring and a diol compound (B1), a proportion of the isocyanato compound (A1) in monomer components is the above-described proportion of the structural unit (b1), and a proportion of the diol compound (B1) in monomer components is the above-described proportion of the structural unit (b2). In addition, in a case of a polymer obtained by an elimination reaction during synthesis, for example, in a case of polyamide obtained by a condensation polymerization of a bifunctional acid chloride compound (A2) having an aromatic ring and a compound (B2) having two primary amino groups, a structural unit in which two chlorine atoms are eliminated from the acid chloride compound (A2) corresponds to the above-described structural unit (b1), and a structural unit in which two hydrogen atoms (that is, one hydrogen atom each from the two primary amino groups) are eliminated from the compound (B2) corresponds to the above-described structural unit (b2). Therefore, the content proportions of the above-described structural units (b1) and (b2) can be obtained from mass ratios of these compounds (A2) and (B2).

(b2) Structural Unit Having Hydrogen Bonding Group

The polymer of the above-described component (B) has a structural unit (b2) having a hydrogen bonding group.

The hydrogen bonding group included in the above-described structural unit (b2) means a group having a hydrogen atom capable of forming a hydrogen bond, and examples thereof include a hydroxy group, a carboxy group, a sulfo group, a phosphoric acid group, a phosphonic acid group, an amino group, a sulfanyl group, an amide group, a urethane group, a urea group, a thiourethane group, a thiourea group, and a sulfonamide group.

Among the above, the hydroxy group, the carboxy group, the sulfo group (sulfonic acid group, —S(═O)₂(OH)), the phosphoric acid group (—OP(═O)(OH)₂), the phosphonic acid group (—P(═O)(OH)₂), and the sulfanyl group are monovalent groups.

Among the above, the amino group, the amide group, and the sulfonamide group mean monovalent groups or divalent groups having a hydrogen-bonding hydrogen atom. These monovalent groups means an amino group (—NH₂), an amide group (—CONH₂), and a sulfonamide group (—SO₂NH₂), respectively, and these divalent groups having a hydrogen-bonding hydrogen atom mean an amino group (>NH), an amide group (—CONH—), and a sulfonamide group (—SO₂NH—), respectively.

Among the above, the urethane group (—NHC(═O)O—), the urea group (—NR^{a}C(═O)NH—), the thiourethane group (—NHC(═O)S— or —NHC(═S)O—), and the thiourea group (—NR^{a}C(═S)NH—) are divalent groups having a hydrogen-bonding hydrogen atom.

The R^{a} is a hydrogen atom, an alkyl group, a monovalent aliphatic or aromatic heterocyclic group, or a monovalent aromatic hydrocarbon ring group, and a hydrogen atom is preferable.

The hydrogen bonding group included in the above-described structural unit (b2) is preferably at least one of a hydroxy group, a carboxy group, a sulfo group, a phosphoric acid group, a phosphonic acid group, an amino group, a sulfanyl group, an amide group, a urethane group, a urea group, a thiourethane group, a thiourea group, or a sulfonamide group, and from the viewpoint of further improving the adhesiveness, more preferably at least one of a hydroxy group, an amide group, a urethane group, or a urea group.

The number of hydrogen bonding groups included in one structural unit may be one or two or more, and in a case of including two or more thereof, these two or more hydrogen bonding groups may be partially or entirely the same hydrogen bonding group, or may be different hydrogen bonding groups.

It is preferable that the polymer of the above-described component (B) has a structural unit represented by General Formula (p2) as the above-described structural unit (b2).

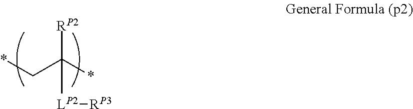

In the formula, R^{P2} represents a hydrogen atom or a methyl group, L^{P2} represent a single bond or a divalent linking group, and R^{P3} represents a monovalent substituent. However, at least one of L^{P2} or R^{P3} includes at least one group of a hydroxy group, a carboxy group, a sulfo group, a phosphoric acid group, a phosphonic acid group, an amino group, a sulfanyl group, an amide group, a urethane group, a urea group, a thiourethane group, a thiourea group, or a sulfonamide group.

* represents a bonding site for incorporation into a polymer.

As the hydroxy group, carboxy group, sulfo group, phosphoric acid group, phosphonic acid group, amino group, sulfanyl group, amide group, urethane group, urea group, thiourethane group, thiourea group, and sulfonamide group included in at least one of L^{P2} or R^{P3}, the description of the hydroxy group, carboxy group, sulfo group, phosphoric acid group, phosphonic acid group, amino group, sulfanyl group, amide group, urethane group, urea group, thiourethane group, thiourea group, and sulfonamide group as the hydrogen bonding group included in the above-described structural unit (b2) can be adopted.

The group represented by -L^{P2}-R^{P3} is interpreted based on the following rules (i) to (iii). It is assumed that the rule (i) has the highest priority, the rule is subsequently applied, and the rule (iii) is finally applied.
(i) in the group represented by -L^{P2}-R^{P3}, in a case where a structure positioned at the most terminal of the longest bonding chain counted from a carbon atom to which R^{P2} is bonded (hereinafter, also referred to as “most terminal structure”) corresponds to a monovalent group in the above-described hydrogen bonding group, R^{P3} is interpreted as the monovalent group in the above-described hydrogen bonding group and the remainder is interpreted as L^{P2}.
(ii) in a case of not corresponding to (i) described above and in a case where an atom constituting the longest bonding chain, which is positioned on a side of the above-described most terminal structure, is a ring-constituting atom, R^{P3} is interpreted as a monovalent ring group including the ring-constituting atom and the remainder is interpreted as L^{P2}.
(iii) in a case of not corresponding to (i) or (ii) described above, an atom constituting the longest bonding chain is counted from a side of the above-described most terminal structure to a side of the carbon atom to which R^{P2} is bonded; and a position to be an atom constituting the bonding chain is the first atom having the monovalent group in the above-described hydrogen bonding group as a substituent or a position to be the divalent group in the above-described hydrogen bonding group is interpreted as L^{P2} and R^{P3}, which is an atom or an atomic group bonded to R^{P3} among atoms constituting L^{P2}.

For example, since the group represented by -L^{P2}-R^{P3} in the structural unit having a hydrogen bonding group (structural unit described on the right terminal) constituting the exemplary polymer (P-21) described later does not fall under the rules (i) and (ii), based on the above-described rule (iii), R^{P3} is interpreted as a 2-acryloyloxyethyl group and L^{P2} is interpreted as —C(═O)O-ethylene-OC(═O)NH—.

L^{P2} represents a single bond or a divalent linking group.

Examples of the divalent linking group which can be adopted as L^{P2} include an alkylene group, an arylene group, a heteroarylene group, a group selected from —O—, —S—, >C(═O), >C(═S), or >NR^{a}, and a linking group consisting of a combination of two or more of these groups.

As R^{a}, the description of R^{a} in the hydrogen bonding group included in the above-described structural unit (b2) can be adopted.

The alkylene group and arylene group which can form L^{P2} may have a substituent. Examples of the substituent which may be included in the alkylene group and arylene group which can form L^{P2} include an alkyl group, a cycloalkyl group, an alkoxy group, an acyl group, an acyloxy group, an alkoxycarbonyl group, a hydroxy group, a carboxy group, a sulfo group, a phosphoric acid group, a phosphonic acid group, an amino group (—N(R^{X})₂), a sulfanyl group, an amide group (—CON(R^{X})₂ or —NR^{x}COR^{Z}), and a sulfonamide group (—SO₂N(R^{X})₂ or —NR^{X}SO₂R^{Z}), and a hydroxy group is preferable. R^{X} is a hydrogen atom, an alkyl group, a monovalent aliphatic or aromatic heterocyclic group, or a monovalent aromatic hydrocarbon ring group, and a hydrogen atom is preferable. R^{Z} is a hydroxy group, an alkyl group, a monovalent aliphatic or aromatic heterocyclic group, or a monovalent aromatic hydrocarbon ring group, and a hydroxy group is preferable.

The number of substituents is not particularly limited, and for example, may be 1 to 4.

Examples of the above-described linking group consisting of a combination of two or more of the groups selected from —O—, —S—, >C(═O), >C(═S), or >NR^{a} include —OC(═O)—, —C(═O)O—, —OC(═O)O—, —NR^{a}C(═O)—, —C(═O)NR^{a}—, —OC(═O)NR^{a}—, —NR^{a}C(═O)O—, —NR^{a}C(═O)NR^{a}—, —SC(═O)—, —C(═O)S—, —OC(═S)O—, —SC(═O)O—, —OC(═O)S—, —NR^{a}C(═S)—, —C(═S)NR^{a}—, —SC(═O)NR^{a}—, —OC(═S)NR^{a}—, —NR^{a}C(═S)O—, —NR^{a}C(═O)S—, and —NR^{a}C(═S)NR^{a}—; and —OC(═O)—, —C(═O)O—, —OC(═O)O—, —NR^{a}C(═O)—, —C(═O)NR^{a}—, —OC(═O)NR^{a}—, —NR^{a}C(═O)O—, —NR^{a}C(═O)NR^{a}—, or —NR^{a}C(═O)S— is preferable, and —OC(═O)—, —C(═O)O—, —NR^{a}C(═O)—, —C(═O)NR^{a}—, —OC(═O)NR^{a}—, —NR^{a}C(═O)O—, or —NR^{a}C(═O)NR^{a}— is more preferable. In the above description of the linking group, it is assumed that the left side is bonded to the carbon atom to which R^{P2} is bonded and the right side is bonded to R^{P3}. The same applies to the followings.

In addition, preferred examples thereof also include a group consisting of a combination of an alkylene group or an arylene group, and at least one of a group selected from —O—, —S—, >C(═O), >C(═S), or >NR^{a}, or a linking group consisting of a combination of two or more of these groups. Examples thereof include —C(═O)NH-alkylene group, —C(═O)O-alkylene group, —C(═O)NH-arylene group, and —C(═O)O-arylene group. In addition, preferred examples thereof also include a group in which an alkylene group in the —C(═O)NH-alkylene group or the —C(═O)O-alkylene group or an arylene group in the —C(═O)NH-arylene group or the —C(═O)O-arylene group is further combined with —OC(═O)—, —C(═O)O—, —NR^{a}C(═O)—, —C(═O)NR^{a}—, —OC(═O)NR^{a}—, —NR^{a}C(═O)O—, —NR^{a}C(═O)NR^{a}—, —SC(═O)—, —C(═O)S—, —NR^{a}C(═S)—, —C(═S)NR^{a}—, —SC(═O)NR^{a}—, —OC(═S)NR^{a}—, —NR^{a}C(═S)O—, —NR^{a}C(═O)S—, or —NR^{a}C(═S)NR^{a}.

As L^{P2}, a single bond, —C(═O)O—, —C(═O)NR^{a}—, —C(═O)NH-alkylene group, —C(═O)O-alkylene group, —C(═O)NH-arylene group, —C(═O)O-arylene group, or a group in which an alkylene group in the —C(═O)NH-alkylene group or the —C(═O)O-alkylene group or an arylene group in the —C(═O)NH-arylene group or the —C(═O)O-arylene group is further combined with —OC(═O)—, —C(═O)O—, —NR^{a}C(═O)—, —C(═O)NR^{a}—, —OC(═O)NR^{a}—, —NR^{a}C(═O)O—, —NR^{a}C(═O)NR^{a}—, —SC(═O)—, —C(═O)S—, —NR^{a}C(═S)—, —C(═S)NR^{a}—, —SC(═O)NR^{a}—, —OC(═S)NR^{a}—, —NR^{a}C(═S)O—, —NR^{a}C(═O)S—, or —NR^{a}C(═S)NR^{a}— is preferable; and a single bond, —C(═O)NH-alkylene group, —C(═O)O-alkylene group, —C(═O)NH-arylene group, —C(═O)O-arylene group, or a group in which an alkylene group in the —C(═O)NH-alkylene group or the —C(═O)O-alkylene group or an arylene group in the —C(═O)NH-arylene group or the —C(═O)O-arylene group is further combined with —OC(═O)—, —C(═O)O—, —NR^{a}C(═O)—, —C(═O)NR^{a}—, —OC(═O)NR^{a}—, —NR^{a}C(═O)O—, or —NR^{a}C(═O)NR^{a}— is more preferable.

R^{P3} represents a monovalent substituent.

Preferred examples of the monovalent substituent as R^{P3} include an alkyl group, a monovalent aliphatic or aromatic heterocyclic group, an aryl group, a hydroxy group, a carboxy group, a sulfo group, a phosphoric acid group, a phosphonic acid group, a sulfanyl group, —NH₂, —CONH₂, and —SO₂NH₂.

The alkyl group, monovalent aliphatic or aromatic heterocyclic group, and aryl group which can be adopted as R^{P3} may be substituted with a substituent. Examples of the substituent which may be included in the alkyl group, monovalent aliphatic or aromatic heterocyclic group, and aryl group which can be adopted as R^{P3} include the polymerizable group in Pol¹ and Pol² described above, and among these, a (meth)acryloyloxy group is preferable. For example, as an alkyl group having a substituent, an alkyl group having a polymerizable group, such as a (meth)acryloyloxyalkyl group, is mentioned.

As R^{P3}, an alkyl group, an aryl group, a hydroxy group, a carboxy group, a sulfo group, a phosphoric acid group, a phosphonic acid group, a sulfanyl group, —NH₂, —CONH₂, or —SO₂NH₂ is preferable, an alkyl group, an aryl group, a hydroxy group, or —CONH₂ is more preferable, and an alkyl group, a hydroxy group, or —CONH₂ is still more preferable.

In the above-described structural unit represented by General Formula (p2), from the viewpoint of further improving the transmittance, it is preferable that the group represented by -L^{P2}-R^{P3} includes a polymerizable group in addition to at least one group of a hydroxy group, a carboxy group, a sulfo group, a phosphoric acid group, a phosphonic acid group, an amino group, a sulfanyl group, an amide group, a urethane group, a urea group, a thiourethane group, a thiourea group, or a sulfonamide group, and it is preferable to include a polymerizable group in addition to at least one of a urethane group, a urea group, or an amide group.

Examples of the above-described structural unit represented by General Formula (p2) include the following structural units. However, the above-described structural unit represented by General Formula (p2) is not limited to these structural units.

In the following chemical structural formulae, R represents a hydrogen atom or a methyl group.

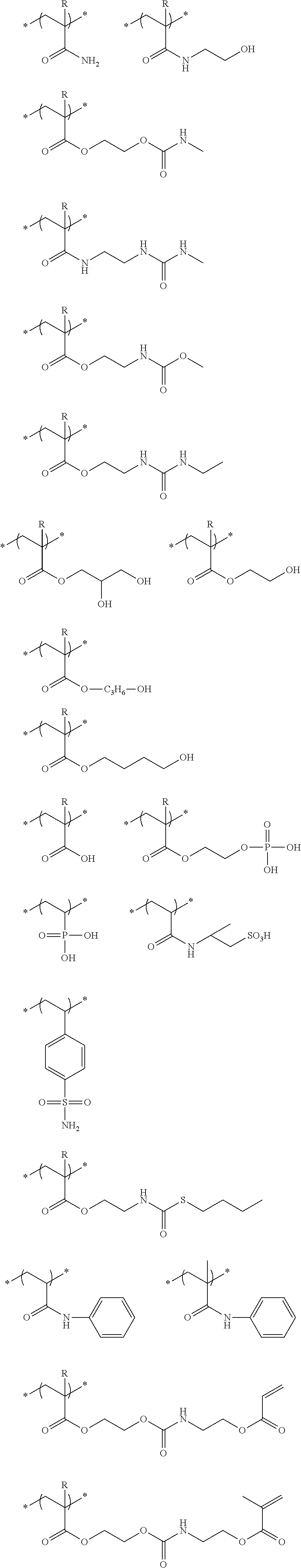

A proportion of the structural unit (b2) having a hydrogen bonding group in all structural units constituting the polymer is preferably 3% to 90% by mass, from the viewpoint of further improving the adhesiveness, more preferably 4% to 80% by mass, and from the viewpoint of further improving the transmittance, still more preferably 5% to 70% by mass.

In a case where the polymer of the component (B) has a structural unit other than the structural units (b1) and (b2) (other structural units), a proportion of the structural unit (b2) having a hydrogen bonding group in all structural units constituting the polymer is preferably 3% to 30% by mass, more preferably 4% to 25% by mass, and still more preferably 5% to 20% by mass.

From the viewpoint of further improving the adhesiveness and the moisture-heat resistance, the polymer of the component (B) is preferably a vinyl polymer, and more preferably a vinyl polymer which has the structural unit represented by General Formula (p1) described above as the structural unit (b1) and the structural unit represented by General Formula (p2) described above as the structural unit (b2).

(b3) Other Structural Units

The polymer of the component (B) may contain a structural unit (hereinafter, also referred to as “other structural units”) other than the above-described structural units (b1) and (b2).

The above-described other structural units are not particularly limited as long as the structural unit is a structural unit having neither the aromatic ring nor the hydrogen bonding group described above, and examples thereof include structural units derived from common monomers such as a (meth)acrylic acid ester compound, a vinyl ester compound, a (meth)acrylonitrile compound, and a maleic acid anhydride compound. By containing these structural units, it is possible to make adjustments so as to further improve the transmittance and the moisture-heat resistance.

Among these, preferred examples of the monomer for deriving the other structural units include a monomer selected from a (meth)acrylic acid ester compound, a (meth)acrylonitrile compound, or the like, and a (meth)acrylic acid ester compound is more preferable.

Specific examples thereof include acrylic acid ester compounds such as alkyl acrylate (the number of carbon atoms in an alkyl group is preferably 1 to 20) (specifically, for example, methyl acrylate, ethyl acrylate, propyl acrylate, butyl acrylate, amyl acrylate, ethylhexyl acrylate, octyl acrylate, t-octyl acrylate, chloroethyl acrylate, glycidyl acrylate, methoxybenzyl acrylate, tetrahydrofurfuryl acrylate, and the like); methacrylic acid ester compounds such as alkyl methacrylate (the number of carbon atoms in an alkyl group are preferably 1 to 20) (specifically, for example, methyl methacrylate, ethyl methacrylate, propyl methacrylate, isopropyl methacrylate, amyl methacrylate, hexyl methacrylate, cyclohexyl methacrylate, chlorobenzyl methacrylate, octyl methacrylate, glycidyl methacrylate, tetrahydrofurfuryl methacrylate, and the like); acrylonitrile; and methacrylonitrile.

Among the above-described monomers, from the viewpoint of further improving the transmittance, an alkyl (meth)acrylate compound having 4 to 20 carbon atoms in the alkyl group is particularly preferable. By making the polymer of the component (B) to contain the structural unit described from such monomers as the other structural units, compatibility between the component (A) and the component (B) in the curable resin composition according to the embodiment of the present invention can be enhanced, and in a case where the curable resin composition according to the embodiment of the present invention further contains a component (C) described later, compatibility of the components (A) to (C) can be enhanced, and a cured product having high transparency can be obtained.

In addition, from the viewpoint of improving the adhesiveness with glass, it is also preferable that the polymer of the component (B) includes, as the other structural units, a structural unit derived from a monomer (compound) having an alkoxysilyl group.

The monomer having an alkoxysilyl group is not particularly limited as long as it is a compound having at least one alkoxy group directly bonded to a silicon atom and having a polymerizable group (preferably, a radically polymerizable group), and it is preferable that the monomer having an alkoxysilyl group is a monomer having a dialkoxysilyl group and/or a trialkoxysilyl group and having a polymerizable group, and it is more preferable to be a monomer having a trialkoxysilyl group and a polymerizable group.

Specific examples thereof include γ-methacryloxypropyltrialkoxysilane, γ-methacryloxypropyldialkoxysilane, and vinyltrialkoxysilane. Among these, γ-methacryloxypropyltrialkoxysilane or γ-acryloxypropyltrialkoxysilane is more preferable. These may be used alone or in combination of two or more kinds.

In a case where the polymer of the component (B) has other structural units, a proportion of the other structural units in all structural units constituting the polymer is preferably 2% to 65% by mass, more preferably 3% to 45% by mass, and still more preferably 5% to 40% by mass.

(Molecular Weight of Component (B))

A mass average molecular weight (Mw) of the polymer of the component (B) is preferably 1,000 or more, more preferably 3,000 or more, and still more preferably 5,000 or more. In addition, the upper limit value of the mass average molecular weight is preferably 500,000 or less, more preferably 300,000 or less, and still more preferably 200,000 or less.

In the present invention, the mass average molecular weight is a weight-average molecular weight in terms of polystyrene according to a gel permeation chromatography (GPC), and a value measured under the following measurement conditions is adopted as the mass average molecular weight. However, an appropriate eluent can be appropriately selected and used depending on a sample to be measured.

(Measurement Condition)
Measuring instrument: HLC-8320GPC (product name, manufactured by Tosoh Corporation)
Column: connection of TOSOH TSKgel HZM-H (product name, manufactured by Tosoh Corporation), TOSOH TSKgel HZ4000 (product name, manufactured by Tosoh Corporation), and TOSOH TSKgel HZ2000 (product name, manufactured by Tosoh Corporation)
Carrier: THF
Measurement temperature: 40° C.
Carrier flow rate: 0.35 ml/min
Sample concentration: 0.1% by mass
Detector: refractive index (RI) detector

Specific examples of the polymer of the component (B) are shown below, but the polymer of the component (B) in the present invention is not limited thereto. ( ) in the following structural formulae means that it is a structural unit, and a numerical value described on the right side of each structural unit means a mass content ratio of each structural unit.

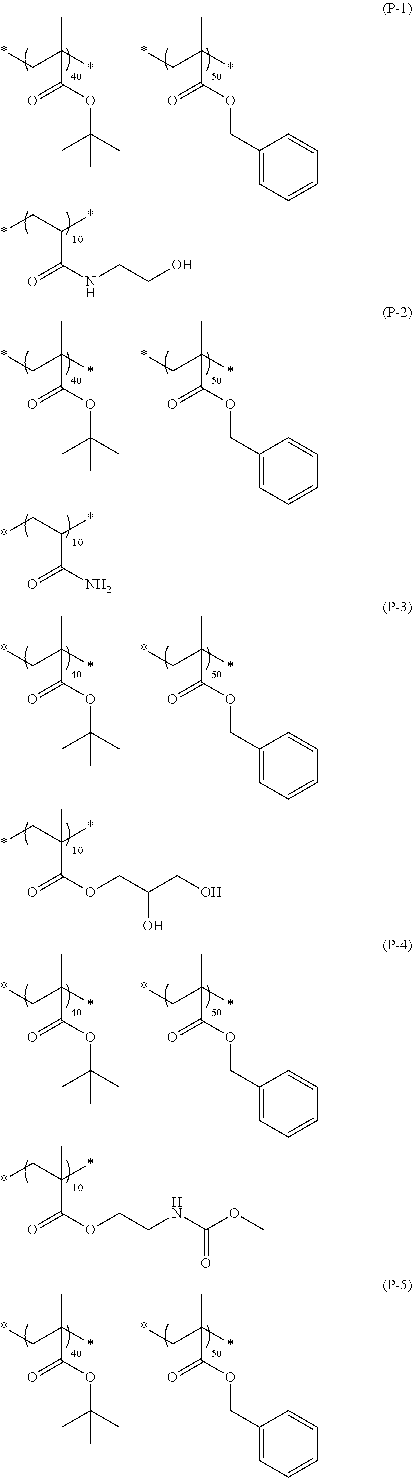

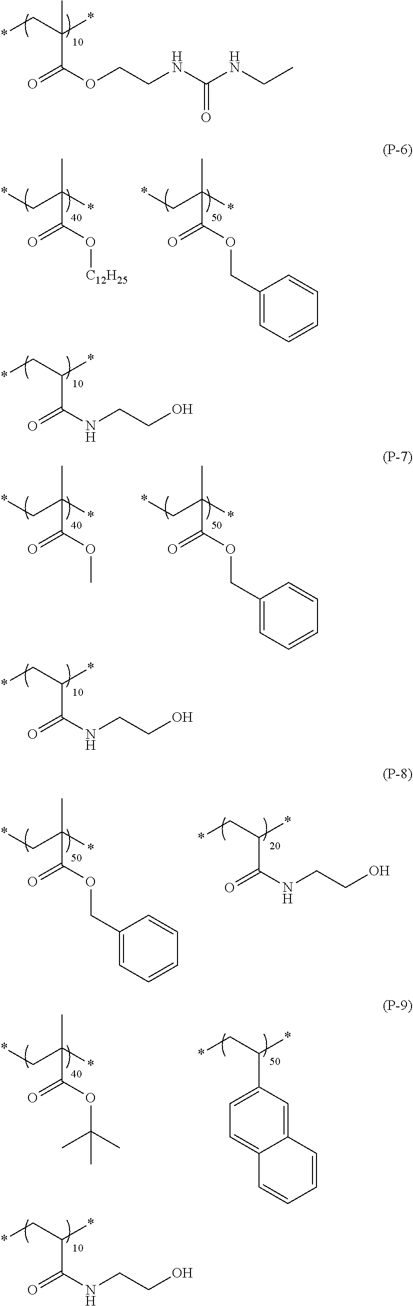

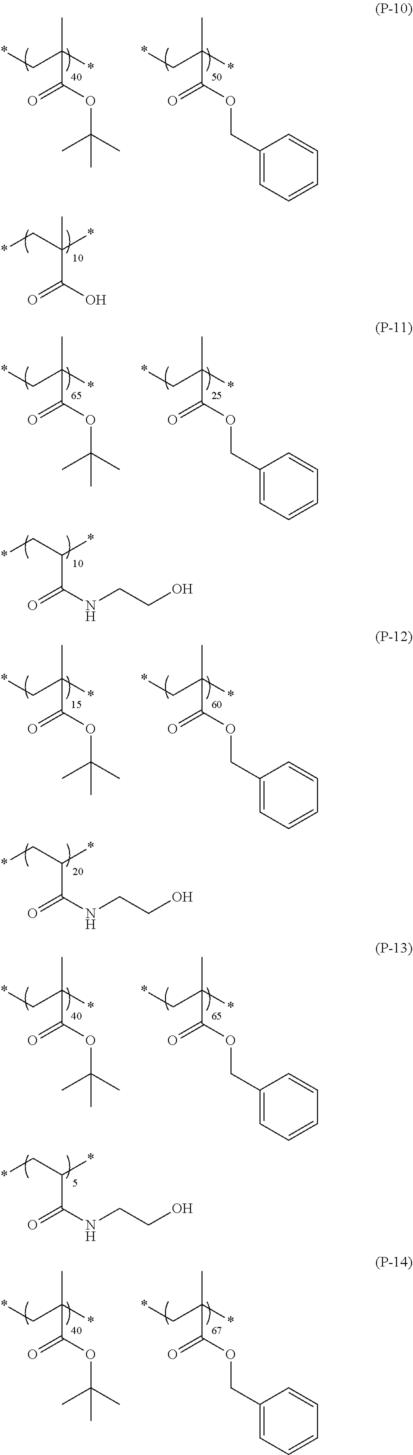

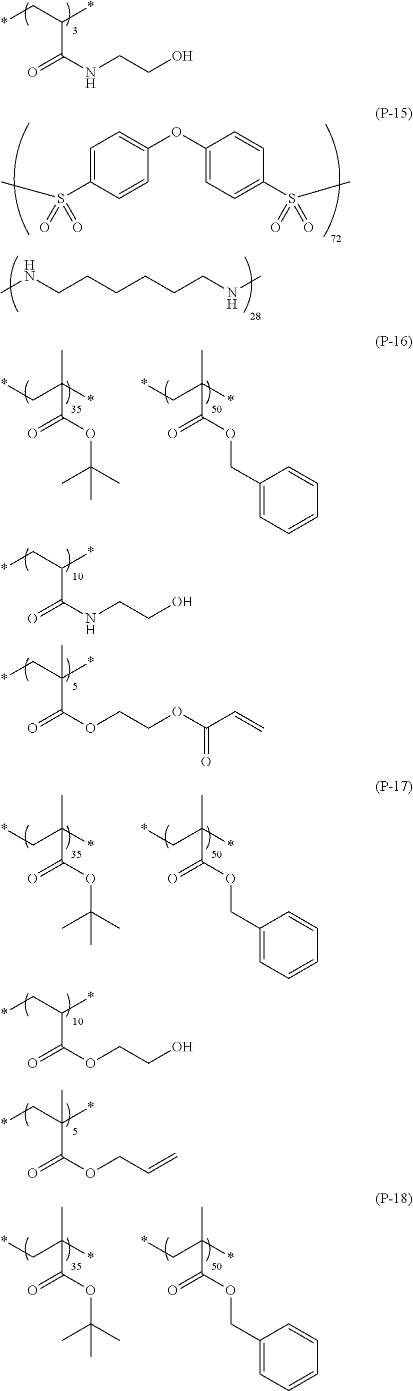

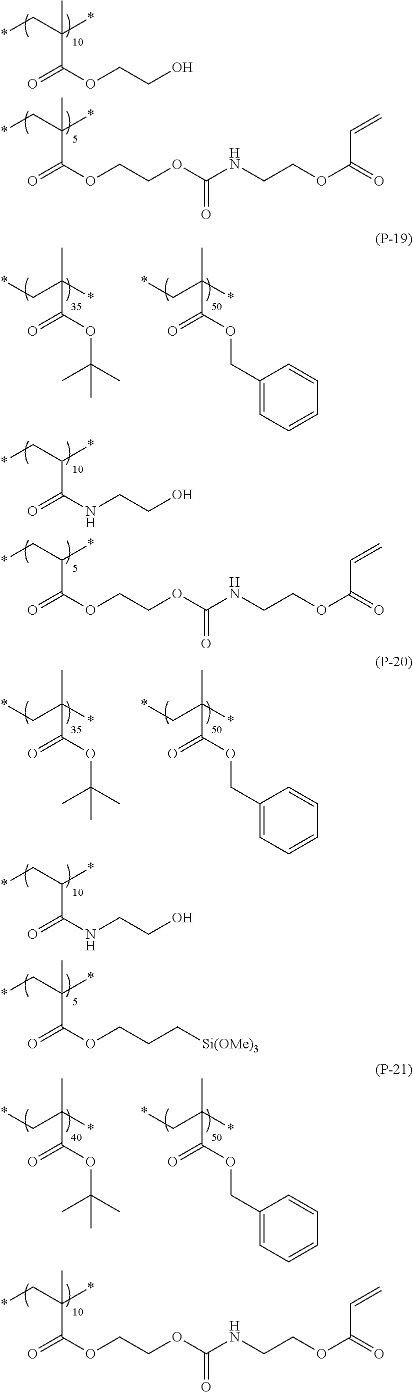

A content of the polymer of the component (B) in the curable resin composition according to the embodiment of the present invention is preferably 60% by mass or less, more preferably 50% by mass or less, and still more preferably 40% by mass or less. The lower limit value thereof is preferably 3% by mass or more, more preferably 5% by mass or more, and still more preferably 10% by mass or more.

<Other Components>

The curable resin composition according to the embodiment of the present invention may further contain other components in addition to the components (A) and (B) described above. Examples of the other components include a component (C): a vinyl monomer, a polymerization initiator, or the like. In addition, a silane coupling agent may be contained, and examples thereof include the monomer having an alkoxysilyl group, which is described in the other structural units of the polymer of the component (B) above.

(Component (C): Vinyl Monomer)

It is also preferable that the curable resin composition according to the embodiment of the present invention contains a vinyl monomer as the component (C). The vinyl monomer is preferably a (meth)acrylate monomer.

The (meth)acrylate monomer may be a polyfunctional (meth)acrylate monomer having two or more (meth)acryloyl groups in the molecule, or may be a monofunctional (meth)acrylate monomer having one (meth)acryloyl group in the molecule. The number of (meth)acryloyl groups in the compound is preferably 1 to 4.

A molecular weight of the vinyl monomer is preferably 100 to 1,000, more preferably 100 to 800, and still more preferably 130 to 800. In addition, the vinyl monomer may be used alone or in combination of two or more thereof.

Examples of the (meth)acrylate monomer which can be preferably used in the present invention include (meth)acrylate monomers described in paragraphs 0037 to 0046 of JP2012-107191A. Specifically, the following monomers can be used.

Specific examples of the (meth)acrylate monomer include monomer 1 (phenoxyethyl acrylate), monomer 2 (benzyl acrylate), monomer 3 (tricyclodecanedimethanol diacrylate), monomer 4 (dicyclopentanyl acrylate), monomer 5 (1,6-hexanediol diacrylate), monomer 6 (1,6-hexanediol dimethacrylate), monomer 8 (isobornyl methacrylate), monomer 9 (dicyclopentanyl methacrylate), monomer 10 (dodecyl methacrylate), monomer 11 (dodecyl acrylate), monomer 12 (2-ethylhexyl methacrylate), monomer 13 (2-ethylhexyl acrylate), monomer 14 (2-hydroxyethyl acrylate), monomer 15 (hydroxypropyl acrylate), monomer 16 (4-hydroxybutyl acrylate), monomer 17 (caprolactone 1 mol adduct of 2-hydroxyethyl acrylate, trade name: PLAKCEL FAlDDM, manufactured by Daicel Corporation), monomer 18 (caprolactone 2 mol adduct of 2-hydroxyethyl acrylate, trade name: PLAKCEL FA2D, manufactured by Daicel Corporation), and monomer 19 (caprolactone-modified hydroxypivalic acid neopentyl glycol diacrylate, trade name: KAYARAD HX-620, manufactured by Nippon Kayaku Co., Ltd.).

For example, the moisture-heat resistance can be further improved by using dodecyl methacrylate or dodecyl acrylate, and the adhesiveness can be further improved by using KAYARAD HX-620 described above.

A method for obtaining the (meth)acrylate monomer is not particularly limited, and the (meth)acrylate compound may be obtained commercially or may be synthesized by a conventional method.

In a case where the curable resin composition according to the embodiment of the present invention contains a vinyl monomer as the component (C), a content of the component (C) in the curable resin composition is preferably 5% to 80% by mass, more preferably 10% to 70% by mass, and still more preferably 20% to 70% by mass. By adjusting the amount of the vinyl monomer in the curable resin composition, it is possible to adjust a function of relieving stress in a case where the cured product undergoes thermal change.

(Polymerization Initiator)

The curable resin composition according to the embodiment of the present invention preferably contains, as the polymerization initiator, at least one of a thermal radical polymerization initiator or a photoradical polymerization initiator.

(Photoradical Polymerization Initiator)

The curable resin composition according to the embodiment of the present invention preferably contains a photoradical polymerization initiator. As the photoradical polymerization initiator, a compound usually used as a photoradical polymerization initiator can be appropriately used according to conditions of a photopolymerization (photocuring) step described later, and specifically, the following compounds can be used.

Examples thereof include bis(2,6-dimethoxybenzoyl)-2,4,4-trimethylpentyl phosphine oxide, bis(2,6-dimethylbenzoyl)-2,4,4-trimethylpentyl phosphine oxide, bis(2,4,6-trimethylbenzoyl)-2,4,4-trimethylpentyl phosphine oxide, bis(2,6-dichlorobenzoyl)-2,4,4-trimethylpentyl phosphine oxide, 1-phenyl-2-hydroxy-2-methylpropan-1-one, 1-hydroxycyclohexylphenylketone, 1-(4-isopropylphenyl)-2-hydroxy-2-methylpropan-1-one, 1,2-diphenylethanedione, methylphenyl glyoxylate, 1-[4-(2-hydroxyethoxy)-phenyl]-2-hydroxy-2-methyl-1-propan-1-one, 2-hydroxy-1-{4-[4-(2-hydroxy-2-methyl-propionyl)-benzyl]phenyl}-2-methyl-propan-1-one, 2,2-dimethoxy-1,2-diphenylethan-1-one, 2-methyl-1-(4-methylthiophenyl)-2-morpholinopropan-1-one, 2-benzyl-2-dimethylamino-1-(4-morpholinophenyl)-butanone-1,2,4,6-trimethylbenzoyl-diphenyl-phosphine oxide, and bis(2,4,6-trimethylbenzoyl)-phenylphosphine oxide.

Among these, in the present invention, as the photoradical polymerization initiator, 1-hydroxycyclohexylphenylketone (Irgacure 184 (product name) manufactured by BASF and the like), bis(2,4,6-trimethylbenzoyl)-phenylphosphine oxide (Irgacure 819 (product name) manufactured by BASF and the like), 2,2,-dimethoxy-1,2-diphenylethan-1-one (Irgacure 651 (product name) manufactured by BASF and the like), 1-[4-(2-hydroxyethoxy)-phenyl]-2-hydroxy-2-methyl-1-propan-1-one, or 2-methyl-1-(4-methylthiophenyl)-2-morpholinopropan-1-one can be preferably used.

In a case of containing a photoradical polymerization initiator, a content of the photoradical polymerization initiator in the curable resin composition according to the embodiment of the present invention is preferably 0.01% to 5.0% by mass, more preferably 0.05% to 1.0% by mass, and still more preferably 0.05% to 0.5% by mass.

(Thermal Radical Polymerization Initiator)

The curable resin composition according to the embodiment of the present invention also preferably contains a thermal radical polymerization initiator. By the action of this thermal radical polymerization initiator, a cured product exhibiting high heat resistance can be molded by thermally polymerizing the above-described curable resin composition.

As the thermal radical polymerization initiator, a compound usually used as a thermal radical polymerization initiator can be appropriately used according to conditions of a thermopolymerization (heat curing) step described later. Examples thereof include organic peroxides, and specifically, the following compounds can be used.

Examples thereof include 1,1-di(t-hexylperoxy) cyclohexane, 1,1-di(t-butylperoxy) cyclohexane, 2,2-di(4,4-di-(t-butylperoxy)cyclohexyl) propane, t-hexylperoxyisopropyl monocarbonate, t-butylperoxy-3,5,5-trimethylhexanoate, t-butylperoxylaurate, dicumyl peroxide, di-t-butyl peroxide, t-butylperoxy-2-ethylhexanoate, t-hexylperoxy-2-ethylhexanoate, cumene hydroperoxide, t-butyl hydroperoxide, t-butylperoxy-2-ethylhexyl, and 2,3-dimethyl-2,3-diphenylbutane.

In a case of containing a thermal radical polymerization initiator, a content of the thermal radical polymerization initiator in the curable resin composition according to the embodiment of the present invention is preferably 0.01% to 10% by mass, more preferably 0.05% to 5.0% by mass, and still more preferably 0.05% to 2.0% by mass.

In a case where the curable resin composition according to the embodiment of the present invention contains both the photoradical polymerization initiator and the thermal radical polymerization initiator, the total content of the photoradical polymerization initiator and the thermal radical polymerization initiator is preferably 0.01% to 5% by mass, more preferably 0.05% to 1.0% by mass, and still more preferably 0.05% to 0.5% by mass with respect to the total mass of the curable resin composition according to the embodiment of the present invention.

As long as it does not contradict the spirit of the present invention, the curable resin composition according to the embodiment of the present invention may contain a component other than the above-described components (A) to (C), polymerization initiator, and silane coupling agent, and for example, the curable resin composition according to the embodiment of the present invention may contain a polymer other than the above-described components, a monomer, a dispersant, a plasticizer, a heat stabilizer, a mold release agent, a solvent, or the like.

A viscosity of the curable resin composition according to the embodiment of the present invention is preferably 60 to 5,000 mPa·s, more preferably 80 to 3,000 mPa·s, and still more preferably 100 to 2,000 mPa·s. By setting the viscosity of the curable resin composition within the above-described range, a high-quality adhesive layer (cured product) having high handleability during adhesion can be formed.

<Cemented Lens>

The cemented lens according to the embodiment of the present invention is a cemented lens including a lens A, an adhesive layer, and a lens B in this order, in which the adhesive layer is a layer consisting of a cured product of the curable resin composition according to the embodiment of the present invention.

In the cemented lens according to the embodiment of the present invention, the cemented lens can be manufactured by adhering two or more lenses using the curable resin composition according to the embodiment of the present invention. For example, the lens A and the lens B are adhered to each other using the curable resin composition according to the embodiment of the present invention so that a cemented lens including the lens A, the layer (adhesive layer) consisting of the cured product of the curable resin composition according to the embodiment of the present invention, and the lens B in this order can be manufactured.

Since the cemented lens manufactured using the curable resin composition according to the embodiment of the present invention has a structure in which the adhesive layer that absorbs ultraviolet light and has excellent fastness against ultraviolet ray irradiation is provided inside, the cemented lens can be used as an optical lens which has a function of cutting ultraviolet rays. In a device such as an imaging module using this cemented lens, by arranging a constituent member including a resin cured product or the like, which is susceptible to ultraviolet rays, on an opposite side of the cemented lens to an incident side of external light, it is possible to prevent deterioration by light. In addition, even in a case where the cemented lens itself has a lens consisting of the resin cured product, or the like, by designing the lens so that the lens faces the adhesive layer on a side opposite to an incident side of external light to the adhesive layer during use, high durability can be achieved.

The cemented lens can be obtained by superimposing two lenses with the curable resin composition according to the embodiment of the present invention, and then curing the adhesive to form the adhesive layer as described below. It is preferable that the curing is performed after the above-described superposition and after removing air bubbles mixed in the adhesive.

[Adhesive Layer]

The adhesive layer is a layer obtained by curing the curable resin composition according to the embodiment of the present invention. For example, in the manufacture of the cemented lens, the adhesive layer is formed by applying the curable resin composition according to the embodiment of the present invention on a surface of one of lenses to be cemented, superimposing the other lens, and then performing curing. The curing can be performed by carrying out at least light irradiation. In addition, a step of further heating may be performed after the light irradiation.

As a light source used for the light irradiation, a light source which emits light having a wavelength at which the photoradical polymerization initiator reacts can be optionally selected. For example, a halogen xenon lamp, a metal halide lamp, a low pressure mercury lamp, a high pressure mercury lamp, an ultra-high pressure mercury lamp, a germicidal lamp, a xenon lamp, a light emitting diode (LED) light source lamp, and the like are suitably used. A laser may be used to selectively radiate light having a wavelength in a narrow range. The atmosphere during the light irradiation is preferably an atmosphere replaced with air or an inert gas, and more preferably an atmosphere in which air is replaced with nitrogen until the oxygen concentration is 1% or less.

A heating temperature in carrying out the heating step is 60° C. or higher, preferably 70° C. to 200° C., more preferably 70° C. to 190° C., and still more preferably 80° C. to 180° C.

A thickness of the adhesive layer is preferably 10 to 50 μm and more preferably 20 to 30 μm. By setting the thickness to 10 μm or more, the effect of absorbing ultraviolet rays can be sufficiently obtained. In addition, by setting the thickness to 50 μm or less, it is possible to improve transmittance in a short wavelength range (400 to 430 nm) of visible light while exhibiting high adhesiveness.

A refractive index of the adhesive layer at a wavelength of 587 nm is preferably 1.51 or more, more preferably 1.53 or more, and still more preferably 1.55 or more. The reason for this is because a difference in refractive indices from a lens to be cemented is small.

In addition, a cutoff wavelength of the adhesive layer having a film thickness of 30 μm is preferably 380 nm or less, more preferably 385 nm or less, and still more preferably 390 nm or less. A wavelength at which a transmittance of the adhesive layer is 0.5% or less is defined as the cutoff wavelength. The transmittance of the adhesive layer can be measured using a spectrophotometer (for example, UV-2550 (product name) manufactured by Shimadzu Corporation).

In the curable resin composition according to the embodiment of the present invention, by adjusting the amount of the compound represented by General Formula (1), the refractive index and cutoff wavelength of the adhesive layer can be adjusted within the above-described ranges.

[Lens A and Lens B]

The lens A and the lens B are lenses which form the cemented lens. In the present invention, during use of the cemented lens, a lens closer to an incident side of external light (side of an object (object to be imaged)) is referred to as the lens A, and a lens farther from the incident side of external light is referred to as the lens B.

In the cemented lens including the lens A, the adhesive layer, and the lens B in this order, materials constituting the lens A and the lens B are not particularly limited, but it is preferable that at least one lens of the lens A or the lens B is a glass lens, it is more preferable that the lens A is a glass lens and the lens B is a resin lens or a composite lens having a resin layer on a surface, and it is preferable that the lens A is a glass lens and the lens B is a composite lens having a resin layer on a surface.

In a case where the lens B is the composite lens, in the cemented lens, it is preferable that the resin layer is in contact with the adhesive layer. This is because, by adopting the structure in which the adhesive layer which is a resin and the resin layer are in contact with each other, a difference in refractive index between the layers can be minimized and interfacial reflection in the cemented lens can be reduced. In addition, this is because, by providing the adhesive layer on the surface of the resin layer having a larger surface roughness than that of glass, an uneven surface of the resin layer is flattened and light scattering due to the roughness of the surface of the resin layer can be prevented.

The types of lenses used as the lens A, the lens B, and a lens C described later are not particularly limited, and examples thereof include a disk-shaped convex lens, a concave lens, a meniscus lens, an aspherical lens, a cylindrical lens having a cylindrical lens surface, a ball lens, and a rod lens.

(Glass Lens)

As the glass lens, a known glass lens can be used without limitation. Examples of a commercially available glass lens include BK7 manufactured by OHARA INC.

The same glass lens can be used in a case where the composite lens includes a glass lens.

(Resin Lens and Composite Lens)

The resin lens means a lens made of a resin cured product.

In the present invention, the composite lens means a lens including a layer made of glass and a resin layer. The resin layer is a layer made of a resin cured product. Each layer included in the composite lens may be a lens (single lens), and in this case, it is preferable that optical axes of the single lenses (lines connecting centers of curvature of both spherical surfaces) are aligned. The composite lens may have a resin layer on the surface thereof, or may have a resin layer inside, and it is preferable that the composite lens used as the lens B has a resin layer on the surface thereof. Typical examples of the composite lens used as the lens B include a composite lens in which a resin layer is formed on a surface of a glass lens.

In a case where the lens B is a resin lens or a composite lens, a resin cured product constituting the resin layer in the resin lens or the composite lens is not particularly limited, but a resin cured product having a low Abbe number is preferable. The resin cured product having a low Abbe number generally absorbs light up to a long wavelength side (approximately 320 nm to 400 nm) in an ultraviolet wavelength range, so that the resin cured product is liable to be deteriorated by light. This is because, by controlling the structure of the compound contained in the curable resin composition according to the embodiment of the present invention and a film thickness in a case where the adhesive layer is formed, the adhesive layer can absorb light up to the long wavelength side of the ultraviolet range, so that it is possible to remarkably suppress the deterioration of the above-described resin cured product having a low Abbe number by light. Specifically, the Abbe number of the above-described resin cured product is preferably 30 or less and more preferably 25 or less.

It is preferable that the resin cured product forming the resin layer of the resin lens or composite lens, which constitutes the lens B, further has a higher partial dispersion ratio θg, F. The partial dispersion ratio θg, F is not particularly limited, but is preferably 0.65 or more and more preferably 0.70 or more. In addition, the partial dispersion ratio θg, F is not particularly limited, but is preferably 2 or less.

The Abbe number (νd) and the partial dispersion ratio (θg, F) of the resin cured product are values calculated by the following expressions.

νd=(nd−1)/(nF−nC)

θg,F=(ng−nF)/(nF−nC)

Here, nd represents a refractive index at a wavelength of 587.56 nm, nF represents a refractive index at a wavelength of 486.13 nm, nC represents a refractive index at a wavelength of 656.27 nm, and ng represents a refractive index at a wavelength of 435.83 nm.

Specifically, the Abbe number of the resin cured product can be obtained using a Kalnew precision refractometer KPR-2000 (manufactured by Shimadzu Device Corporation), Abbe Meter (manufactured by ATAGO CO., LTD.) or the like.

Examples of the resin for forming the resin cured product having an Abbe number of 30 or less include resins including a structure such as 9,9′-diarylfluorene, naphthalene, biphenyl, carbazole, benzothiazole, and benzotriazole (specifically, for example, resins described in JP1985-38411A (JP-S60-38411A), JP1998-67977A (JP-H10-67977A), JP2002-47335, JP2004-83855A, JP2005-325331A, JP2007-238883A, JP2012-52016, JP2012-1498A, JP2016-75911A, WO2006/095610A, JP1990-29401A (JP-H2-29401A), and the like). In addition, a cured product of a composition containing a compound described in paragraphs 0112 to 0124 of WO2019/131572A can also be preferably used.

<Device: Imaging Module>

The curable resin composition according to the embodiment of the present invention is used in a device including an optical lens inside, thereby preventing deterioration by light of the optical lens and the device. Specifically, in a device equipped with a resin lens or a composite lens including a resin layer, by arranging an adhesive layer formed from the curable resin composition according to the embodiment of the present invention in a direction in which external light is incident on the resin lens or the composite lens of a housing (light shielding properties), it is possible to prevent deterioration of the resin lens or the composite lens by light. The adhesive layer can be provided, for example, as a part of the above-described cemented lens.

Examples of the device including an optical lens inside, in which the curable resin composition according to the embodiment of the present invention is used, include an imaging module which forms an image by imaging an object using a lens optical system. Examples of a target of incorporating the imaging module include electronic apparatuses such as digital cameras, personal computer (PC) built-in or external PC cameras, camera-equipped interphones, vehicle-mounted cameras, endoscopes, and mobile terminal apparatuses with a photographing function. Examples of the mobile terminal apparatus include mobile phones, smartphones, personal digital assistants (PDA), and portable game machines.

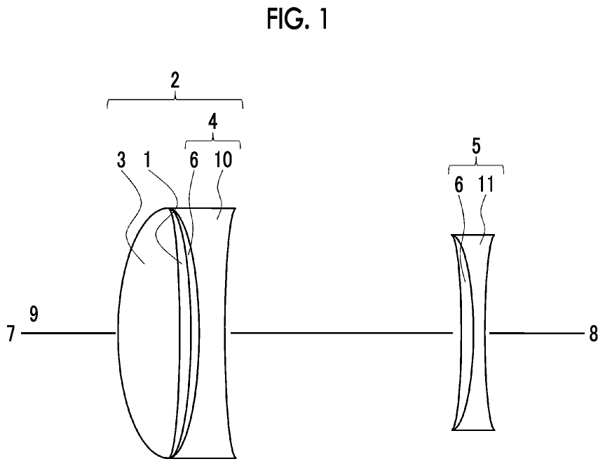

FIG. 1 schematically shows an example of the above-described lens optical system including the adhesive layer formed from the curable resin composition according to the embodiment of the present invention.

In FIG. 1, a lens A (3), an adhesive layer 1, a lens B (4), and a lens C (5) are arranged in this order from an object (object to be imaged) side 7 to an image forming surface side 8, the lens B (4) and the lens C (5) are each a composite lens, the lens B (4) is composed of a resin layer 6 and a layer 10 made of glass, and the lens C (5) is composed of a resin layer 6 and a layer 11 made of glass. In addition, in FIG. 1, the lens A (3), the adhesive layer 1, and the lens B (4) constitute a cemented lens 2.

In the lens optical system shown in FIG. 1, it is possible to prevent deterioration by light of the resin layer 6 in the composite lens arranged as the lens B (4) or the lens C (5), which is located on the image forming surface side 8 with respect to the adhesive layer 1. In addition, in FIG. 1, even in a case of a lens optical system in which a resin lens is adopted instead of the composite lens as the lens B (4) and/or the lens C (5), it is possible to prevent deterioration by light of the composite lens and/or the resin lens located at the positions of the lens B (4) and the lens C (5). In addition to these lens optical systems, for example, the following lens optical systems can prevent the deterioration by light of constituent lenses:
(1) a lens optical system which includes only a cemented lens of the lens A which is a glass lens and the lens B which is a composite lens, and does not include the lens C;
(2) a lens optical system in which the lens A and the lens B are glass lenses, and the lens C is a composite lens or a resin lens; and
(3) a lens optical system including additional one or more lenses in addition to the optical system according to (1) or (2).

[Lens C]

As described above, the lens optical system in an imaging module, which includes the adhesive layer formed from the curable resin composition according to the embodiment of the present invention, may include a lens C. In the present invention, the “lens C” refers to a lens other than the cemented lens in which lenses are adhered to each other using the curable resin composition according to the embodiment of the present invention and the lenses constituting the cemented lens, and refers to a lens farther from the incident side of external light (side of an object (object to be imaged)) than the cemented lens including the adhesive layer formed from the curable resin composition according to the embodiment of the present invention.

A material constituting the lens C is not particularly limited, but the lens C is preferably a resin lens or a composite lens. This is because, in a case where the lens C is a resin lens or a composite lens, the effect of suppressing the deterioration by light due to absorption ultraviolet rays in the cemented lens including the adhesive layer formed from the curable resin composition according to the embodiment of the present invention is particularly high.

The composite lens used as the lens C may have a resin layer on a surface thereof, or may have a resin layer inside.

Preferred ranges and examples of the resin layer in the resin lens or the composite lens constituting the lens C are the same as those described above as the resin layer in the resin lens or the composite lens constituting the lens B.

### EXAMPLES

Hereinafter, the present invention will be described in more detail based on Examples. The materials, amounts used, proportions, treatment details, treatment procedures, and the like described in the following examples can be appropriately modified as long as the gist of the invention is maintained. Therefore, the scope of the present invention should not be construed as being limited to the following specific examples.

In the following synthesis example, the room temperature means 25° C.

All steps from the preparation of the curable resin composition to the test of the cured product were carried out in an environment where a yellow lamp was used as lighting.

### Synthesis Example

The component (A) and the component (B) were synthesized as follows.

The abbreviations used in the synthesis of each component described below indicate the followings.
EDAC: 1-ethyl-3-(3-dimethylaminopropyl)carbodiimide hydrochloride
HPMA: hydroxypropyl methacrylate
DMAc: N,N-dimethylacetamide
THF: tetrahydrofuran
Ac: acetyl group
Et: ethyl group

### Synthesis of Component (A)

### Synthesis Example 1: Synthesis of Compound (I-6)

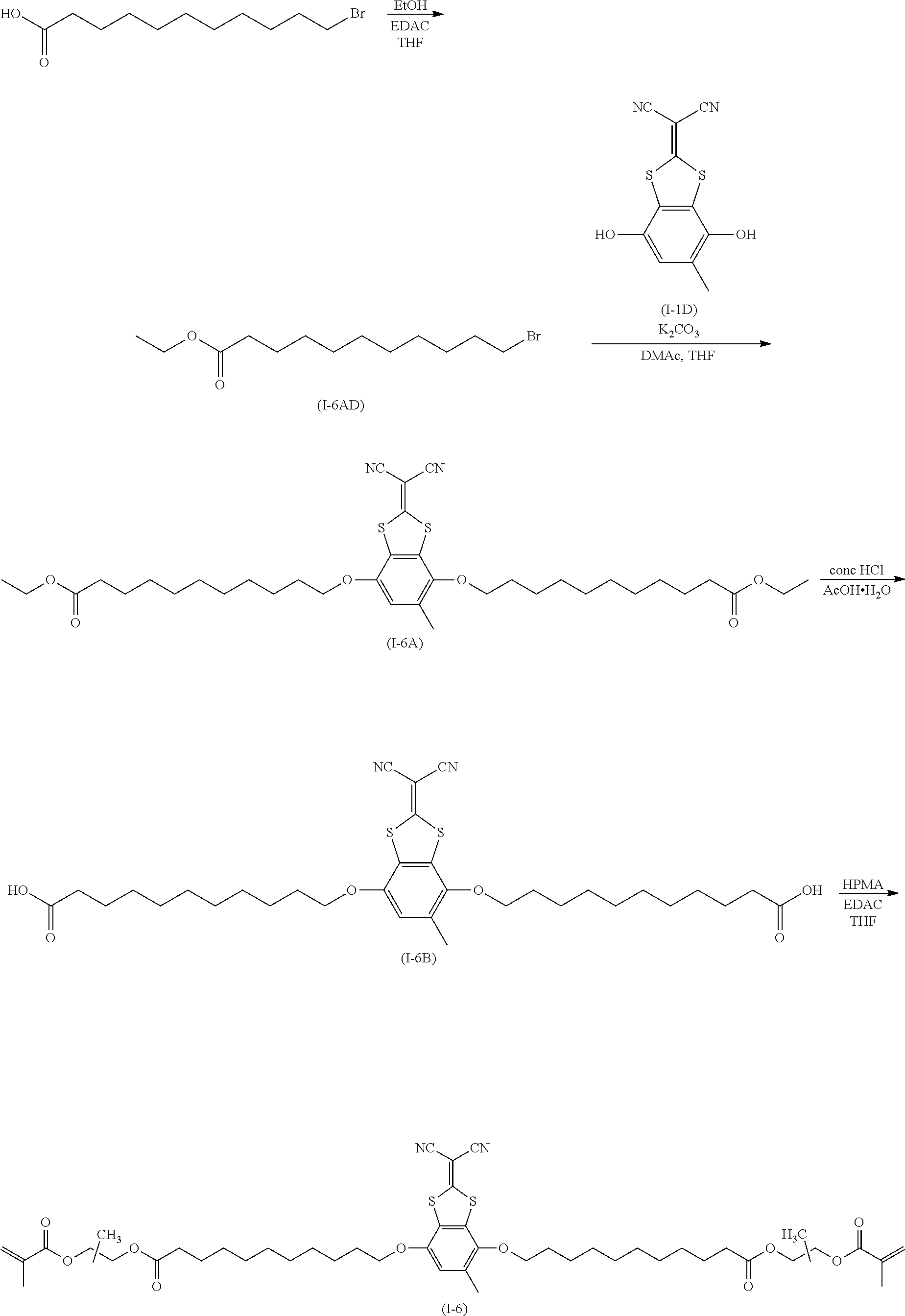

<Synthesis of Compound (I-6A0)>

Ethyl 11-bromoundecanoate (compound (I-6A0)) was synthesized by the same method described in Bulletin of the Chemical Society of Japan, 81, 1518 (yield: 90%).

<Synthesis of Compound (I-6A)>

While mixing 36.9 g (125.8 mmol) of the compound (I-6A0), 15 g (57.2 mmol) of a compound (I-1D), 17.4 g (125.8 mmol) of potassium carbonate, 60 mL of THF, and 90 mL of N,N-dimethylacetamide, and the mixture was heated so that an internal temperature (liquid temperature) was 80° C. After stirring at 80° C. for 3 hours, 150 mL of ethyl acetate, 180 mL of water, and 30 mL of concentrated hydrochloric acid were added thereto, and the mixture was stirred, washed, and liquid-separated. Next, 150 mL of a 5% sodium hydrogen carbonate aqueous solution was added thereto, and the mixture was stirred, washed, and liquid-separated. Thereafter, 230 mL of methanol was added to the organic layer, and the precipitated crystals were filtered to obtain a compound (I-6A) (yield: 65%).

<Synthesis of Compound (I-6B)>

After mixing 20 g (30.6 mmol) of the compound (I-6A), 20 mL of concentrated hydrochloric acid, 240 mL of acetic acid, and 80 mL of water, the mixture was stirred at 80° C. for 1 hour. Thereafter, the temperature was returned to 25° C., 200 mL of water was added thereto, and then the precipitated solid was filtered, washed with methanol and water, and dried at 50° C. to obtain a compound (I-6B) (yield: 90%).

<Synthesis of Compound (I-6)>

18 g (28.5 mmol) of the carboxylic acid compound (I-6B), 45 mL of ethyl acetate, 9.1 g (62.8 mmol) of hydroxypropyl methacrylate, 0.4 g (2.9 mmol) of N,N-dimethylaminopyridine, and 12 g (62.8 mmol) of 1-ethyl-3-(3-dimethylaminopropyl)carbodiimide hydrochloride (abbreviation: EDAC) were mixed. After stirring at 40° C. for 2 hours, 300 ml of 1N hydrochloric acid was added thereto, the mixture was washed and liquid-separated, a 5% sodium hydrogen carbonate aqueous solution was added thereto, and the mixture was washed and liquid-separated. An oily composition was obtained by dehydration with magnesium sulfate, filtration, concentration, and then purified by column chromatography to obtain a compound (I-6) (yield: 70%).

¹H-NMR (300 MHz, CDCl₃): δ (ppm) 1.25 to 1.50 (m, 30H), 1.50 to 1.70 (m, 8H), 1.95 (s, 6H), 2.20 to 2.40 (m, 7H), 3.85 (t, 2H), 4.0 (t, 2H), 4.10 to 4.30 (m, 4H), 5.10 to 5.30 (m, 2H), 5.60 (s, 2H), 6.10 (s, 2H), 6.70 (s, 1H)

### Synthesis Example 2: Synthesis of Compound (I-5)

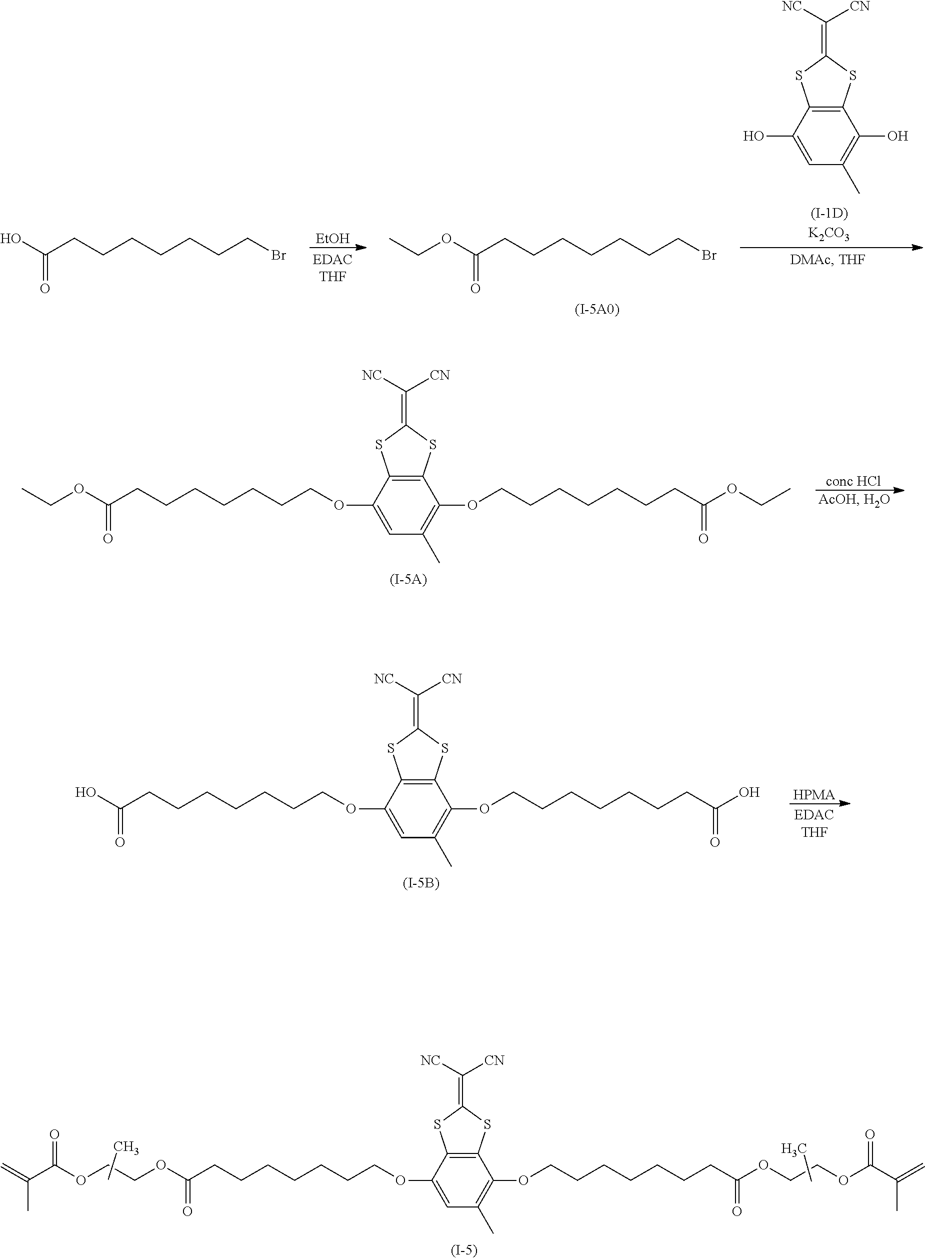

<Synthesis of Compound (I-5A0)>

Ethyl 8-bromooctanoate (compound (I-5A0)) was synthesized by the same method as in the synthesis of the compound (I-6A0), except that 11-bromoundecanoic acid was changed to 8-bromooctanoic acid (yield: 88%).

<Synthesis of Compound (I-5A)>

A compound (I-5A) was synthesized in the same method as in the synthesis of the compound (I-6A), except that the compound (I-6A0) was changed to the compound (I-5A0) (yield: 67%).

<Synthesis of Compound (I-5B)>

A compound (I-5B) was synthesized in the same method as in the synthesis of the compound (I-6B), except that the compound (I-6A) was changed to the compound (I-5A) (yield: 97%).

<Synthesis of Compound (I-5)>

A compound (I-5) was synthesized in the same method as in the synthesis of the compound (I-6), except that the compound (I-6B) was changed to the compound (I-5B) (yield: 60%).

¹H-NMR (300 MHz, CDCl₃): δ (ppm) 1.25 to 1.50 (m, 18H), 1.50 to 1.70 (m, 4H), 1.50 to 1.70 (quint, 4H), 1.95 (s, 6H), 2.20 to 2.40 (m, 7H), 3.85 (t, 2H), 4.0 (t, 2H), 4.10 to 4.30 (m, 4H), 5.10 to 5.30 (m, 2H), 5.60 (s, 2H), 6.10 (s, 2H), 6.70 (s, 1H)

[Synthesis of Compound (Y-1)]

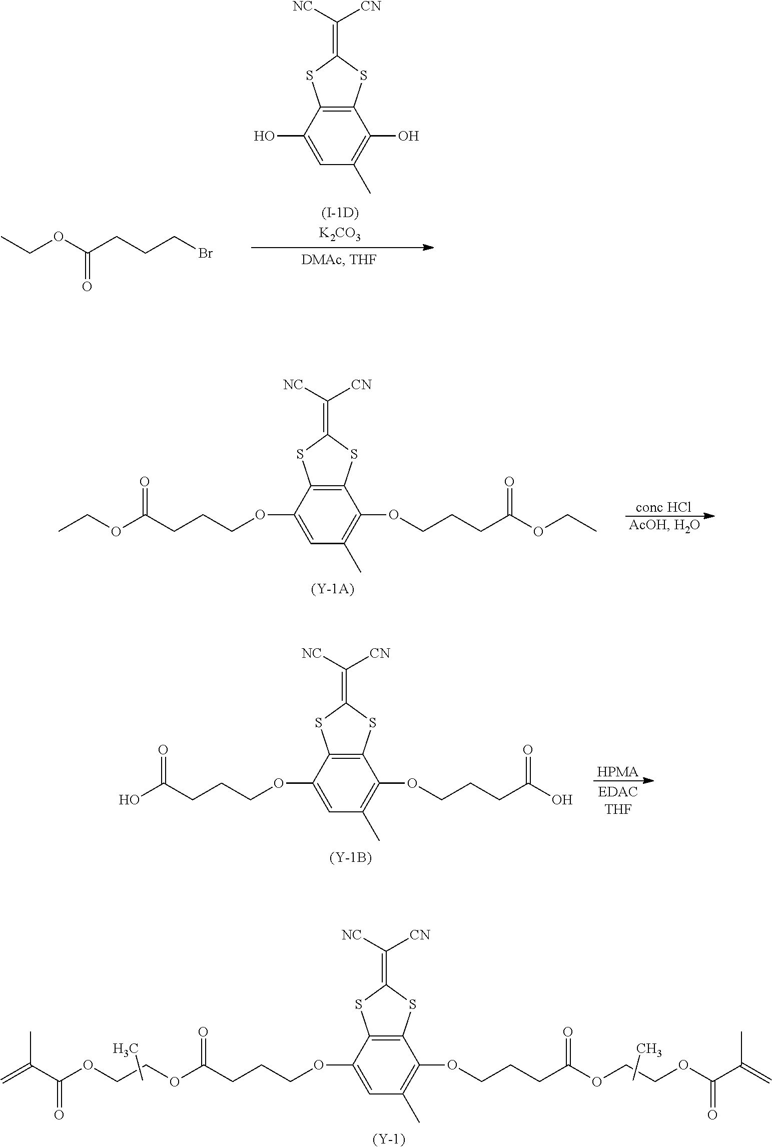

A compound (Y-1) was synthesized in the same method as in the synthesis of the compound (I-6), except that the raw material compound (I-6A0) in the synthesis of the compound (I-6) was changed to ethyl bromobutyrate.

¹H-NMR (300 MHz, CDCl₃): δ (ppm) 1.25 to 1.35 (d, 6H), 1.95 (s, 6H), 2.10 to 2.20 (m, 4H), 2.31 (s, 3H), 2.50 to 2.70 (m, 4H), 3.90 (t, 2H), 4.0 to 4.4 (m, 6H), 5.10 to 5.30 (m, 2H), 5.60 (s, 2H), 6.10 (s, 2H), 6.70 (s, 1H)

[Synthesis of Compound (V-3)]

The following compound (V-3) was synthesized according to the synthesis method of compound (V-3), which is described in paragraphs 0144 to 0146 of WO2019/131572A.

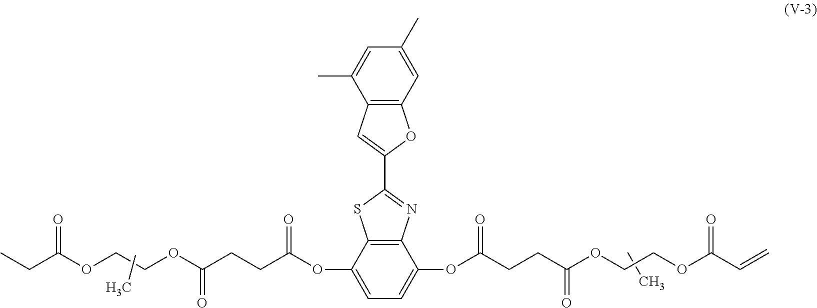

### Synthesis of Component (B)

[Synthesis of Polymer P-1]

25.0 g of benzyl methacrylate (manufactured by FUJIFILM Wako Pure Chemical Corporation), 20.0 g of tert-butyl methacrylate (manufactured by FUJIFILM Wako Pure Chemical Corporation), and 5.0 g of N-(2-hydroxyethyl)acrylamide (manufactured by Tokyo Chemical Industry Co., Ltd.) were dissolved in 35 mL of methyl ethyl ketone and heated to 70° C. under a nitrogen stream. A solution in which 1.0 g of a polymerization initiator (manufactured by FUJIFILM Wako Pure Chemical Corporation, product name: V-65) was dissolved in 45 mL of methyl ethyl ketone was added dropwise to the solution over 30 minutes. After completion of the dropwise addition, the reaction was further performed at 70° C. for 4.5 hours. After allowing to cool, the reaction solution was added dropwise to a cooled mixed solution of 200 mL of water and 1800 mL of methanol, and the precipitated powdery substance was collected by filtration and dried to obtain 40 g of a polymer P-1.

[Synthesis of Polymers P-2 to P-14 and Comparative Polymers 1, 3, and 4]

The following polymers P-2 to P-14 and comparative polymers 1, 3, and 4 were synthesized in the same manner as in the synthesis of the polymer P-1 described above, except that the type of monomer and blending ratio of monomers were changed as appropriate to obtain polymers having the following structures.

[Synthesis of Polymer P-15]

6.97 g of 1,6-hexane diamine (manufactured by Tokyo Chemical Industry Co., Ltd.) and 53.9 g of N-methylpyrrolidone (manufactured by KANTO KAGAKU) were weighed in a three-necked flask equipped with a condenser and a stirrer, and the reaction solution was stirred at room temperature under a nitrogen flow to form a homogeneous solution. Next, 9.49 g of pyridine (manufactured by KANTO KAGAKU) and 7.33 g of 4-dimethylaminopyridine (manufactured by Tokyo Chemical Industry Co., Ltd.) were weighed and added to the reaction solution to be dissolved. Next, 22.03 g of 4,4′-oxybis(benzenesulfonyl chloride) (manufactured by Tokyo Chemical Industry Co., Ltd.) was added to the flask, and the reaction solution was stirred at room temperature for 1 hour, heated to 60° C., and reacted for 10 hours. The reaction solution was added dropwise to a mixed solution of 0.5 L of pure water and 0.5 L of methanol to precipitate a polymer. The polymer was collected by filtration, washed, and dried to obtain 25.5 g of a polymer P-15.

[Synthesis of Polymer P-21]

30 mL of cyclohexanone was weighed in a three-necked flask equipped with a condenser and a stirrer, and heated to 80° C. under a nitrogen stream. A solution obtained by dissolving 21.0 g of benzyl methacrylate (manufactured by FUJIFILM Wako Pure Chemical Corporation), 17.0 g of tert-butyl methacrylate (manufactured by FUJIFILM Wako Pure Chemical Corporation), 2.0 g of 2-hydroxyethyl methacrylate (manufactured by FUJIFILM Wako Pure Chemical Corporation), and a polymerization initiator (manufactured by FUJIFILM Wako Pure Chemical Corporation, product name: V-601) in 60 mL of cyclohexanone was added dropwise thereto over 120 minutes under a nitrogen stream. After completion of the dropwise addition, a polymerization reaction was further carried out at 80° C. for 6 hours.

After allowing the reaction solution to cool to room temperature and bringing the reaction solution into an air atmosphere, 4.3 g of Karenz AOI (product name, 2-acryloyloxyethyl isocyanate, manufactured by SHOWA DENKO K.K.), 0.14 g of NEOSTANN U-600 (product name, manufactured by Nitto Kasei Co., Ltd.) as a catalyst, 0.04 g of 2-tert-butyl-1,4-benzoquinone (manufactured by Tokyo Chemical Industry Co., Ltd.) as a polymerization inhibitor, and 10 mL of cyclohexanone were added thereto, and the reaction solution was heated to 70° C. and reacted for 6 hours.

After allowing to cool, the reaction solution was added dropwise to a cooled mixed solution of 200 mL of water and 1800 mL of methanol, and the precipitated powdery substance was collected by filtration and dried to obtain 32 g of a polymer P-21.

The structures of the respective polymers are summarized below. ( ) in the following structural formulae means that it is a structural unit, and a numerical value described on the right side of each structural unit means a mass content ratio of each structural unit.

In addition, the mass average molecular weight (Mw) of each polymer is a value measured under the above-described measurement conditions.

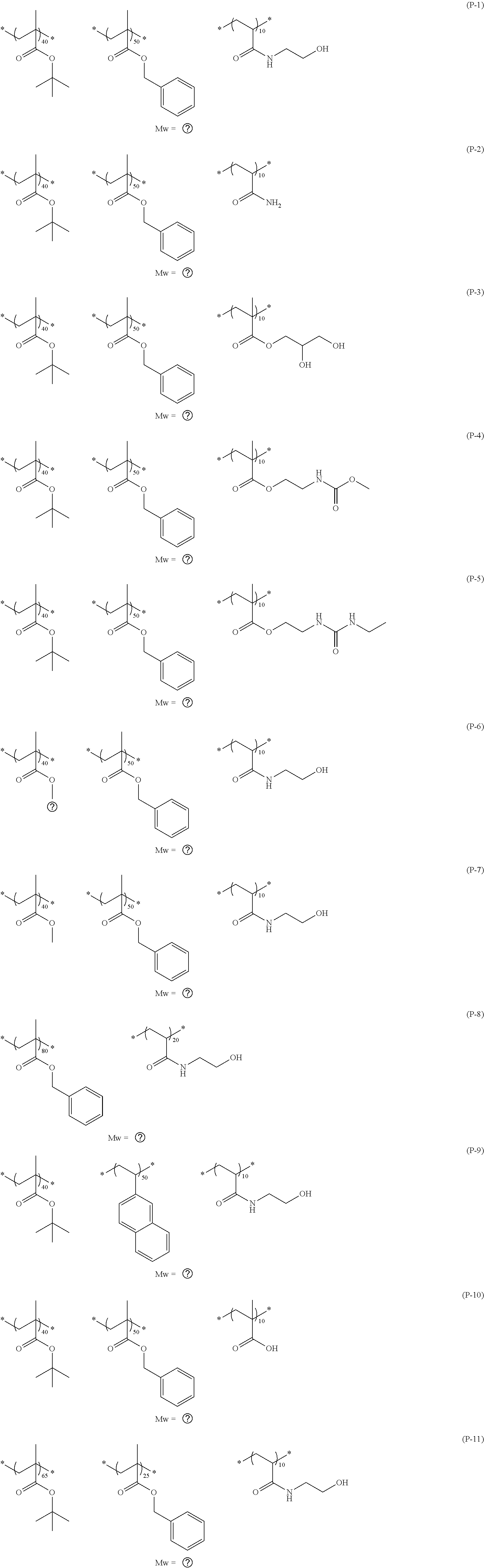

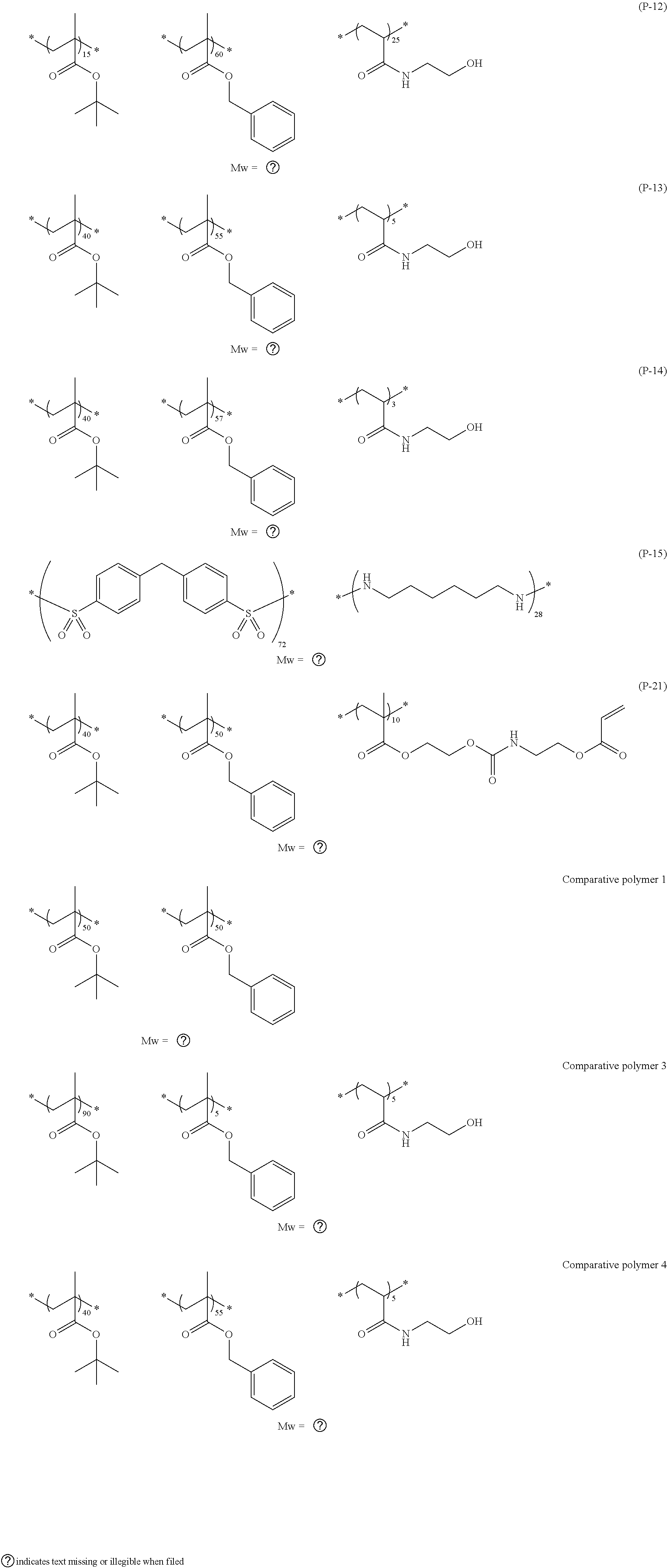

### Example 1: Preparation of Curable Resin Composition

(1) Preparation of Curable Resin Composition

A curable resin composition was prepared by mixing the component (A), the component (B) or a comparative polymer, the component (C), and a photopolymerization initiator in an amount having composition shown in the tables below, and stirring the mixture homogeneously.

Evaluation results of the obtained curable resin compositions are summarized in the tables below.

In the comparative curable resin compositions No. c03 and c04, even in a case where the respective components were mixed, the liquid did not become homogeneous and phase separation occurred, so that subsequent evaluations could not be performed.

[Evaluation 1: Adhesive Force]
(1) Production of Cured Product Sample for Adhesive Force Test

2 μL of the curable resin composition prepared above was placed on an end part of a slide glass cut into a rectangle having a width of 12 mm and a length of 30 mm. The curable resin composition was uniformly spread over an overlapped portion by sandwiching between the slide glass and a slide glass cut to the same size such that the overlapped portion had a width of 12 mm and a length of 5 mm. In an atmosphere with an oxygen concentration of 1% or less, using EXECURE 3000 (product name, manufactured by HOYA CORPORATION) as an UV irradiation device, the curable resin composition was irradiated with ultraviolet rays of 2 J/cm², thereby obtaining a bonded sample (sample for tensile shear test) having a width of 12 mm and a length of 55 mm.

(2) Adhesive Force Test

Using TENSILON RTC-1225A (product name, manufactured by A&D Company), a tensile shear test was performed on the bonded sample produced by the above-described method under the following conditions, and a load in a case where the bonded portion of the sample peeled off was measured. The test was carried out 5 times for one curable resin composition, and adhesive force was evaluated based on the following evaluation standard using an average value of measurement results of the 5 times as an indicator of the adhesive force. As the indicator of the adhesive force is larger, the adhesive force is more excellent.

(Conditions)
Distance between chucks: 40 mm
Test temperature: 25° C.
Tensile rate: 2 mm/sec

—Evaluation Standard—
AA: indicator of the adhesive force was 100 N or more.

A: indicator of the adhesive force was 70 N or more and less than 100 N.

B: indicator of the adhesive force was 40 N or more and less than 70 N.

C: indicator of the adhesive force was 20 N or more and less than 40 N.

D: indicator of the adhesive force was less than 20 N.

[Evaluation 2: Moisture-Heat Resistance]

(1) Production of Cemented Lens for Moisture-Heat Resistance Test

Between a biconvex glass lens A (glass material: BK7, outer diameter: 10 mm, curvature radius of a surface to be bonding surface: 12 mm, curvature radius of the other surface: 10 mm) and a biconcave glass lens B (glass material: BK7, outer diameter: 10 mm, curvature radius of a surface to be bonding surface: 12 mm, curvature radius of the other surface: 10 mm), 2 μL of the curable resin composition prepared above was sandwiched so as to be spread uniformly over a bonding surface. Thereafter, in an atmosphere with an oxygen concentration of 1% or less, using EXECURE 3000 (product name, manufactured by HOYA CORPORATION) as an UV irradiation device, the sample was irradiated with ultraviolet rays of 2 J/cm² from the lens A side to obtain a cemented lens.

(2) Moisture-Heat Resistance Test

Each of the 20 cemented lenses produced by the above-described method was stored at 60° C. and 90% RH (relative humidity) for 240 hours, the temperature was returned to room temperature (25° C.), and a morphology of the test sample was observed using a digital microscope manufactured by KEYENCE CORPORATION and a laser microscope.

A cemented lens with shape changes such as cracks and interfacial peeling was judged as a defective product, and a cemented lens without the shape changes was judged as a non-defective product. A proportion of non-defective products (non-defective product ratio) was applied to the following standard to evaluate moisture-heat resistance. As the non-defective product ratio is higher, the moisture-heat resistance is more excellent.

—Evaluation Standard—
AA: non-defective product ratio was 90% or more.

A: non-defective product ratio was 80% or more and less than 90%.

B: non-defective product ratio was 70% or more and less than 80%.

C: non-defective product ratio was less than 70%.

[Evaluation 3: Transmittance]

(1) Production of Cured Product Sample for Evaluation of Transmittance

L of the curable resin composition prepared above was placed on a rectangular slide glass having a length of 76 mm and a width of 52 mm, and the curable resin composition was uniformly spread over an overlapped portion by sandwiching between the slide glass and a glass plate having the same size, so as to have a thickness of 20 μm.

In an atmosphere with an oxygen concentration of 1% or less, using EXECURE 3000 (product name, manufactured by HOYA CORPORATION) as an UV irradiation device, the curable resin composition was irradiated with ultraviolet rays of 2 J/cm², thereby obtaining a cured product (cured product sample for evaluation of transmittance) sandwiched between the glass plates.

(2) Measurement of Transmittance

Using a spectrophotometer UV-2600 (product name, manufactured by Shimadzu Corporation), a transmittance T (%) of the cured product sample produced above at 450 nm was measured, and transmittance was evaluated based on the following standard.

—Evaluation Standard—
AA: T % was 90% or more.
A: T % was 89% or more and less than 90%.
B: T % was 88% or more and less than 89%.
C: T % was less than 88%.

TABLE 1-1

| | | | Curable resin composition No. | | | | | | | | | | | | | | | |
|---|---|---|---|---|---|---|---|---|---|---|---|---|---|---|---|---|---|---|
| | | | 101 | 102 | 103 | 104 | 105 | 106 | 107 | 108 | 109 | 110 | 111 | 112 | 113 | 114 | 115 | 116 |
| Composition | Component | Y-1 | 25 | — | — | — | — | — | — | — | — | — | — | — | — | — | — | — |
| | (A) | V-3 | — | 25 | — | — | — | — | — | — | — | — | — | — | — | — | — | — |
| | | I-5 | — | — | 30 | — | — | — | — | — | — | — | — | — | — | — | — | — |
| | | I-6 | — | — | — | 30 | 30 | 30 | 30 | 30 | 30 | 30 | 30 | 30 | 30 | 30 | 30 | 30 |
| | Component | P-1 | 25 | 25 | 20 | 20 | — | — | — | — | — | — | — | — | — | — | — | — |
| | (B) | P-2 | — | — | — | — | 20 | — | — | — | — | — | — | — | — | — | — | — |
| | | P-3 | — | — | — | — | — | 20 | — | — | — | — | — | — | — | — | — | — |
| | | P-4 | — | — | — | — | — | — | 20 | — | — | — | — | — | — | — | — | — |
| | | P-5 | — | — | — | — | — | — | — | 20 | — | — | — | — | — | — | — | — |
| | | P-6 | — | — | — | — | — | — | — | — | 20 | — | — | — | — | — | — | — |
| | | P-7 | — | — | — | — | — | — | — | — | — | 20 | — | — | — | — | — | — |
| | | P-8 | — | — | — | — | — | — | — | — | — | — | 20 | — | — | — | — | — |
| | | P-9 | — | — | — | — | — | — | — | — | — | — | — | 20 | — | — | — | — |
| | | P-10 | — | — | — | — | — | — | — | — | — | — | — | — | 20 | — | — | — |
| | | P-11 | — | — | — | — | — | — | — | — | — | — | — | — | — | 20 | — | — |
| | | P-12 | — | — | — | — | — | — | — | — | — | — | — | — | — | — | 20 | — |
| | | P-13 | — | — | — | — | — | — | — | — | — | — | — | — | — | — | — | 20 |
| | | P-14 | — | — | — | — | — | — | — | — | — | — | — | — | — | — | — | — |
| | | P-15 | — | — | — | — | — | — | — | — | — | — | — | — | — | — | — | — |
| | | P-21 | — | — | — | — | — | — | — | — | — | — | — | — | — | — | — | — |
| | Component | Dodecyl acrylate | 50 | 50 | 50 | 50 | 50 | 50 | 50 | 50 | 50 | 50 | 50 | 50 | 50 | 50 | 50 | 50 |
| | (C) | HX-620 | — | — | — | — | — | — | — | — | — | — | — | — | — | — | — | — |
| | | 4-Hydroxybutyl acrylate | — | — | — | — | — | — | — | — | — | — | — | — | — | — | — | — |
| | | PLAKCEL FA1DDM | — | — | — | — | — | — | — | — | — | — | — | — | — | — | — | — |
| | Comparative | Comparative polymer 1 | — | — | — | — | — | — | — | — | — | — | — | — | — | — | — | — |
| | polymer | Comparative polymer 2 | — | — | — | — | — | — | — | — | — | — | — | — | — | — | — | — |
| | | Comparative polymer 3 | — | — | — | — | — | — | — | — | — | — | — | — | — | — | — | — |
| | | Comparative polymer 4 | — | — | — | — | — | — | — | — | — | — | — | — | — | — | — | — |

| | | | | | | | | | | | | | | | | | |
|---|---|---|---|---|---|---|---|---|---|---|---|---|---|---|---|---|---|
| Evaluation | Adhesive force | B | B | A | A | A | A | AA | AA | A | A | A | B | B | A | A | A |
| | Moisture-heat resistance | A | B | A | AA | AA | AA | A | A | AA | AA | A | A | A | AA | A | AA |
| | Transmittance | A | B | A | A | A | A | A | A | A | B | B | A | A | B | B | A |

TABLE 1-2

| | | | Curable resin composition No. | | | | | | | | | | | |
|---|---|---|---|---|---|---|---|---|---|---|---|---|---|---|
| | | | 117 | 118 | 119 | 120 | 121 | 122 | c01 | c02 | c03 | c04 | c05 | c06 |
| Composition | Component | Y-1 | — | — | — | — | — | — | — | — | — | — | — | — |
| | (A) | V-3 | — | — | — | — | — | — | — | — | — | — | — | 25 |
| | | I-5 | — | — | — | — | — | — | — | — | — | — | — | — |
| | | I-6 | 30 | 30 | 30 | 30 | 30 | 30 | 30 | 30 | 30 | 30 | 30 | — |
| | Component | P-1 | — | — | 20 | 20 | 20 | — | — | — | — | — | — | — |
| | (B) | P-2 | — | — | — | — | — | — | — | — | — | — | — | — |
| | | P-3 | — | — | — | — | — | — | — | — | — | — | — | — |
| | | P-4 | — | — | — | — | — | — | — | — | — | — | — | — |
| | | P-5 | — | — | — | — | — | — | — | — | — | — | — | — |
| | | P-6 | — | — | — | — | — | — | — | — | — | — | — | — |
| | | P-7 | — | — | — | — | — | — | — | — | — | — | — | — |
| | | P-8 | — | — | — | — | — | — | — | — | — | — | — | — |
| | | P-9 | — | — | — | — | — | — | — | — | — | — | — | — |
| | | P-10 | — | — | — | — | — | — | — | — | — | — | — | — |
| | | P-11 | — | — | — | — | — | — | — | — | — | — | — | — |
| | | P-12 | — | — | — | — | — | — | — | — | — | — | — | — |
| | | P-13 | — | — | — | — | — | — | — | — | — | — | — | — |
| | | P-14 | 20 | — | — | — | — | — | — | — | — | — | — | — |
| | | P-15 | — | 20 | — | — | — | — | — | — | — | — | — | — |
| | | P-21 | — | — | — | — | — | 20 | — | — | — | — | — | — |
| | Component | Dodecyl acrylate | 50 | 50 | — | 40 | 40 | 40 | 70 | 50 | 50 | 50 | 50 | 50 |
| | (C) | HX-620 | — | — | 50 | — | — | — | — | — | — | — | — | — |
| | | 4-Hydroxybutyl acrylate | — | — | — | 10 | — | 10 | — | — | — | — | — | — |
| | | PLAKCEL FA1DDM | — | — | — | — | 10 | — | — | — | — | — | — | — |
| | Comparative | Comparative polymer 1 | — | — | — | — | — | — | — | 20 | — | — | — | — |
| | polymer | Comparative polymer 2 | — | — | — | — | — | — | — | — | 20 | — | — | 25 |
| | | Comparative polymer 3 | — | — | — | — | — | — | — | — | — | 20 | — | — |
| | | Comparative polymer 4 | — | — | — | — | — | — | — | — | — | — | 20 | — |

| | | | | | | | | | | | | |
|---|---|---|---|---|---|---|---|---|---|---|---|---|
| Evaluation | Adhesive force | B | C | AA | AA | AA | AA | D | D | Cannot be | D | C |
| | Moisture-heat resistance | A | B | A | A | A | A | C | C | evaluated due | C | C |
| | Transmittance | A | A | A | A | A | AA | A | A | to phase | A | C |
| | | | | | | | | | | separation | | |
| | | | | | | | | | | during liquid | | |
| | | | | | | | | | | preparation | | |

<Note to Table>

Each component in the tables is as follows. The blending amount ratio of each component is based on mass.

In any of the curable resin compositions, 0.1 parts by mass of Irgacure 819 (product name, manufactured by BASF Japan) as a photopolymerization initiator was blended with respect the total of 100 parts by mass of the component (A), the component (B) or the comparative polymer, and the component (C).

In addition, “-” means that the component was not contained.

(Component (A))

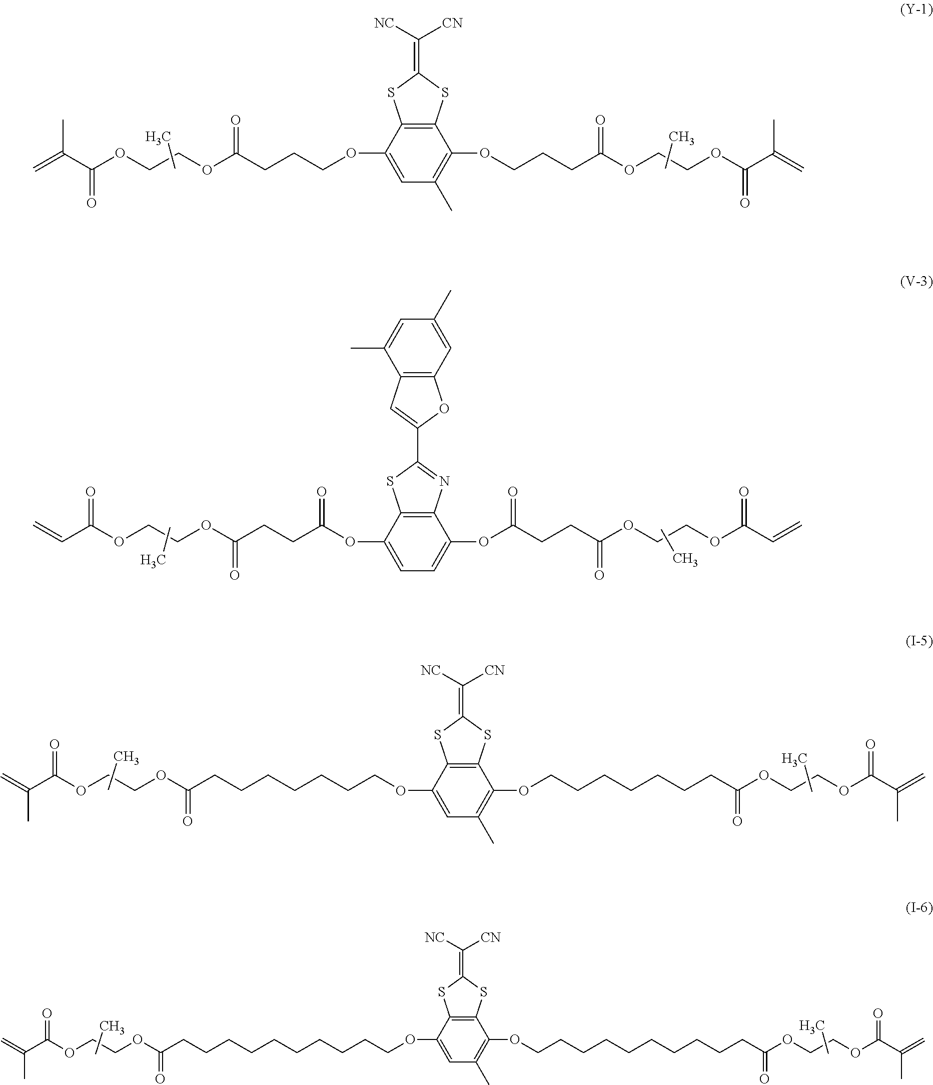

(Component (B))

Polymers P-1 to P-15 and P-21: polymers P-1 to P-15 and P-21 described in Synthesis Examples above

(Component (C): Vinyl Monomer)

HX-620: vinyl monomer represented by the following structural formula, KAYARAD HX-620 (product name, manufactured by Nippon KayakuCo., Ltd.

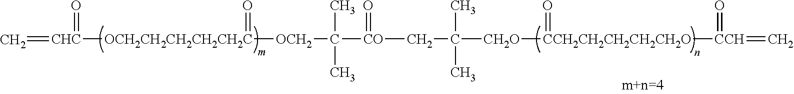

PLAKCEL FAlDDM: product name, manufactured by Daicel Corporation, unsaturated fatty acid hydroxyalkyl ester modified F-caprolactone (molecular weight: 230, composition formula: CH₂═CHCOO(CH₂)₂O[CO(CH₂)₅O]ₙH; n means the number of repetitions)

(Comparative Polymer)

Comparative polymers 1, 3, and 4: comparative polymers 1, 3, and 4 described in Synthesis Examples above

Comparative polymer 2: SHIKOH UV-3000B (product name, manufactured by Mitsubishi Chemical Corporation, urethane acrylate including no aromatic ring, Mw: 18,000)

From the results shown in Table 1, the following is found.

The comparative curable resin composition No. c01 was not the curable resin composition defined by the present invention in that it did not contain a polymer. The cured product obtained from the comparative curable resin composition No. c01 had an indicator of an adhesive force of less than 20 N, indicating deteriorated adhesiveness, and a non-defective product ratio in the moisture-heat resistance test of less than 70%, indicating deteriorated moisture-heat resistance.

In addition, both of the comparative curable resin composition No. c02 and the comparative curable resin composition No. c05 were not the curable resin composition defined by the present invention in that the comparative curable resin composition No. c02 contained, as a polymer, the comparative polymer 1 which did not include the structural unit having a hydrogen bonding group and in that the comparative curable resin composition No. c05 contained, as a polymer, the comparative polymer 4 which included the structural unit having a hydrogen bonding group in an amount of less than 3% by mass. The cured product obtained from the comparative curable resin composition No. c02 or c05 had an indicator of an adhesive force of less than 20 N, indicating deteriorated adhesiveness, and a non-defective product ratio in the moisture-heat resistance test of less than 70%, indicating deteriorated moisture-heat resistance.

In addition, both of the comparative curable resin composition No. c03 and the comparative curable resin composition No. c04 were not the curable resin composition defined by the present invention in that the comparative curable resin composition No. c03 contained, as a polymer, the comparative polymer 2 which did not include the structural unit having an aromatic ring and in that the comparative curable resin composition No. c04 contained, as a polymer, the comparative polymer 3 which included the structural unit having an aromatic ring in an amount of less than 10% by mass. These comparative curable resin compositions No. c03 and c04 had low compatibility between the polymer and the component (A), and phase separation occurred during the preparation of the compositions, which makes it impossible to perform the evaluations. In addition, even in the comparative curable resin composition No. c06 prepared by changing the type of the component (A) with respect to the comparative curable resin composition No. c03, so that the phase separation did not occur in the composition, the phase separation did not occur, but the transmittance of the obtained cured product was as low as less than 88%, and the number of non-defective products in the moisture-heat resistance test was less than 70%, indicating deteriorated moisture-heat resistance.

On the other hand, all of the cured products obtained from the curable resin compositions No. 101 to 122 according to the embodiment of the present invention exhibited high transmittance and high indicator of adhesive force, and were excellent in both adhesiveness and transmittance. Moreover, the number of non-defective products in the moisture-heat resistance test was large, and the moisture-heat resistance was also excellent.

In addition, from the comparison between the cured product obtained from the curable resin composition No. 118 according to the embodiment of the present invention and the cured product obtained from No. 104 to 117, or 122, it was found that, in a case where the polymer of the component (B) was a vinyl polymer, the adhesiveness and the moisture-heat resistance were more excellent.

In addition, from the comparison between the cured product obtained from the curable resin composition No. 102 according to the embodiment of the present invention and the cured product obtained from No. 101, 103, or 104, it was found that, in a case where Ar in General Formula (1) of the component (A) was the aromatic ring group represented by General Formula (2-2), more excellent moisture-heat resistance was exhibited, and higher transmittance was exhibited.

In addition, from the comparison between the cured product obtained from the curable resin composition No. 101 according to the embodiment of the present invention and the cured product obtained from No. 103 or 104, it was found that, in a case where, in General Formula (1) of the component (A), L¹ and L² were —O—, and the number of atoms linking Pol¹ and L¹ and the number of atoms linking Pol² and L² were both 11 to 30, the adhesiveness was more excellent.

As a result, with the curable resin composition according to the embodiment of the present invention, a cured product obtained by a curing reaction has excellent adhesiveness to a glass substrate and also has excellent transmittance.

The present invention has been described with the embodiments thereof, any details of the description of the present invention are not limited unless described otherwise, and it is obvious that the present invention is widely construed without departing from the gist and scope of the present invention described in the accompanying claims.

### EXPLANATION OF REFERENCES

1: adhesive layer
2: cemented lens
3: lens A
4: lens B
5: lens C
6: resin layer
7: object side
8: image forming surface side
9: optical axis
10, 11: layer made of glass

What is claimed is:

1. A curable resin composition comprising:
a component (A); and
a component (B),
the component (A): a compound represented by General Formula (1),
the component (B): a polymer including a structural unit (b1) having an aromatic ring and a structural unit (b2) having a hydrogen bonding group, in which a proportion of the structural unit (b1) in all structural units constituting the polymer is 10% by mass or more and a proportion of the structural unit (b2) in all structural units constituting the polymer is 3% by mass or more,
where the structural unit (b1) has no hydrogen bonding group,
Pol¹-Sp^{a}-L¹-Ar-L²-Sp^{b}-Pol² General Formula (1)
in the formula, Ar represents an aromatic ring group represented by any of General Formula (2-1), . . . , or (2-4),
L¹ and L² represent a single bond, —O—, —S—, —C(═O)—, —OC(═O)—, —C(═O)O—, —OC(═O)O—, —NR¹⁰¹C(═O)—, —C(═O)NR¹⁰²—, —OC(═O)NR¹⁰³—, —NR¹⁰⁴C(═O)O—, —SC(═O)—, or —C(═O)S—,
R¹⁰¹ to R¹⁰⁴ represent —Sp^{c}-Pol³ or a halogen atom,
Sp^{a} and Sp^{b} represent a single bond, a linear alkylene group having 1 to 30 carbon atoms, which may have a substituent, or a group in which, in a linear alkylene group having 2 to 30 carbon atoms, which may have a substituent, one or two or more —CH₂—'s excluding a linking portion to L¹ or L² are substituted by a group selected from —O—, —S—, >C(═O), or >NR¹¹¹,
R¹¹¹ represents —Sp^{d}-Pol⁴ or a halogen atom,
Sp^{c} and Sp^{d} represent a single bond or a divalent linking group, and
Pol¹ and Pol² represent a polymerizable group, and Pol³ and Pol⁴ represent a hydrogen atom or a polymerizable group, 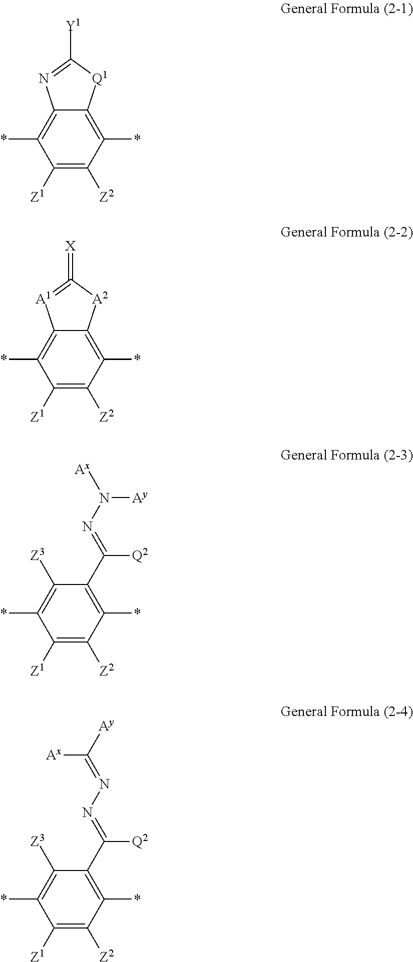
in the formulae, Q¹ represents —S—, —O—, or >NR¹¹, and R¹¹ represents a hydrogen atom or an alkyl group having 1 to 6 carbon atoms,
Y¹ represents an alkyl group having 1 to 6 carbon atoms, an aromatic hydrocarbon group having 6 to 12 carbon atoms, or an aromatic heterocyclic group having 3 to 12 carbon atoms,
Z¹, Z², and Z³ represent a hydrogen atom, an aliphatic hydrocarbon group having 1 to 20 carbon atoms, an alkoxy group having 1 to 20 carbon atoms, an alicyclic hydrocarbon group having 3 to 20 carbon atoms, an aromatic hydrocarbon group having 6 to 20 carbon atoms, a halogen atom, a cyano group, a nitro group, —NR¹²R¹³, or —SR¹², Z¹ and Z² may be bonded to each other to form an aromatic hydrocarbon ring or an aromatic heterocyclic ring, R¹² and R¹³ represent a hydrogen atom or an alkyl group having 1 to 6 carbon atoms,
A¹ and A² represent a group selected from —O—, >NR²¹, —S—, and >C(═O), and R²¹ represents a hydrogen atom or a substituent,
X represents ═O, ═S, a carbon atom to which a hydrogen atom or a substituent is bonded, or a nitrogen atom to which a hydrogen atom or a substituent is bonded,
A^{x} represents an organic group having 1 to 30 carbon atoms, which has at least one aromatic ring selected from an aromatic hydrocarbon ring or an aromatic heterocyclic ring, A^{y} represents a hydrogen atom, an alkyl group having 1 to 6 carbon atoms, or an organic group having 1 to 30 carbon atoms, which has at least one aromatic ring selected from an aromatic hydrocarbon ring or an aromatic heterocyclic ring, A^{x} and A^{y} may be bonded to each other to form a ring,
Q² represents a hydrogen atom or an alkyl group having 1 to 6 carbon atoms, and
* represents a bonding position with L¹ or L².

2. The curable resin composition according to claim 1,
wherein the hydrogen bonding group included in the structural unit (b2) is at least one of a hydroxy group, a carboxy group, a sulfo group, a phosphoric acid group, a phosphonic acid group, an amino group, a sulfanyl group, an amide group, a urethane group, a urea group, a thiourethane group, a thiourea group, or a sulfonamide group.

3. The curable resin composition according to claim 1,
wherein the component (B) is a vinyl polymer.

4. The curable resin composition according to claim 3,
wherein the component (B) is a vinyl polymer which has a structural unit represented by General Formula (p1) as the structural unit (b1) and a structural unit represented by General Formula (p2) as the structural unit (b2), 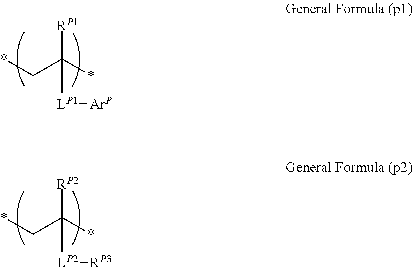
in the formulae, R^{P1} and R^{P2} represent a hydrogen atom or a methyl group, L^{P1} and L^{P2} represent a single bond or a divalent linking group, Ar^{P} represents an aromatic hydrocarbon group which may have a substituent or an aromatic heterocyclic group which may have a substituent, R^{P3} represents a monovalent substituent,
where at least one of L^{P2} or R^{P3} includes at least one group of a hydroxy group, a carboxy group, a sulfo group, a phosphoric acid group, a phosphonic acid group, an amino group, a sulfanyl group, an amide group, a urethane group, a urea group, a thiourethane group, a thiourea group, or a sulfonamide group, and the structural unit represented by General Formula (p1) has no hydrogen bonding group, and
* represents a bonding site for incorporation into a polymer.

5. The curable resin composition according to claim 1,
wherein Ar is the aromatic ring group represented by General Formula (2-2).

6. The curable resin composition according to claim 1,
wherein L¹ and L² are —O—, Sp^{a} is a linking group in which a smallest number of atoms which links Pol¹ and L¹ is 11 to 30, and Sp^{b} is a linking group in which a smallest number of atoms which links Pol² and L² is 11 to 30.

7. A cemented lens comprising, in the following order:
a lens A;
an adhesive layer; and
a lens B,
wherein the adhesive layer is a layer consisting of a cured product of the curable resin composition according to claim 1.

8. The cemented lens according to claim 7,
wherein at least one of the lens A or the lens B is a glass lens.
